(19) United States
(12) Patent Application Publication
(10) Pub. No.: US 2026/0188068 A1
(43) Pub. Date: Jul. 2, 2026

(54) PRIVILEGE INFORMATION ISSUING APPARATUS, SYSTEM, AND METHOD, AND COMPUTER READABLE MEDIUM

(71) Applicant: NEC Corporation, Minato-ku, Tokyo (JP)

(72) Inventors: Eri KOKAJI, Tokyo (JP); Kazufumi HOSHI, Tokyo (JP); Yurie HOSHI, Tokyo (JP); Hiroaki KUJIRAI, Tokyo (JP)

(73) Assignee: NEC Corporation, Minato-ku, Tokyo (JP)

(21) Appl. No.: 18/864,620

(22) PCT Filed: Jul. 28, 2022
(86) PCT No.: PCT/JP2022/029077

§ 371 Date: Nov. 11, 2024

(51) Int. Cl. G07C 9/37

(52) U.S. Cl. CPC G07C 9/37

(57) ABSTRACT

A privilege information issuing apparatus includes: a registration unit that registers entry qualification information with which a user is able to enter an event venue where an event is held through identity authentication and identity authentication information for registering the user who has purchased the entry qualification information in an associated manner; an authentication control unit that controls the identity authentication using identity authentication information for authentication acquired from the user; a specification unit that specifies the entry qualification information associated with the identity authentication information with which the identity authentication has been successful; an issuing unit that issues privilege information that is able to be used in one or more commercial facilities in a neighborhood of the event venue on the basis of the specified entry qualification information; and a notification unit that notifies the user of the issued privilege information.

### TECHNICAL FIELD

The present disclosure relates to a privilege information issuing apparatus, a system, a method, and a program.

### BACKGROUND ART

Patent Literature 1 discloses a technology related to points and coupon system using biometric authentication. Patent Literature 2 discloses a technology of assigning a score set for a terminal installed for biometric authentication to a user who has succeeded in biometric authentication in the terminal and integrating the score into a past score. Patent Literature 3 discloses a technology of associating a user ID with a service, specifying a service associated with a user ID for which biometric authentication has been successful, and granting the specified service as a privilege.

Here, a unique economic zone can be formed in a predetermined region including an event venue and commercial facilities around the event venue. In addition, management of entry to an event venue using identity authentication such as biometric authentication including face authentication has been put into practical use in recent years.

### CITATION LIST

### Patent Literature

Patent Literature 1: Japanese Unexamined Patent Application Publication No. 2021-114035
Patent Literature 2: International Patent Publication No. WO2022/003774
Patent Literature 3: International Patent Publication No. WO2022/044138

### SUMMARY OF INVENTION

### Technical Problem

Here, revitalization of a region including an event venue and commercial facilities around the event venue by sending customers therebetween is required. For example, there is a problem of encouraging purchasers of entry qualification information such as an entry ticket for an event to use commercial facilities in the surroundings.

In view of the above-described problems, an object of the present disclosure is to provide a privilege information issuing apparatus, a system, a method, and a program for encouraging a purchaser of entry qualification information for an event to use commercial facilities around an event venue.

### Solution to Problem

A privilege information issuing apparatus according to the present disclosure includes:
a registration means for registering, in a storage means, entry qualification information with which a user is able to enter an event venue where an event is held through identity authentication and identity authentication information for registering the user who has purchased the entry qualification information in an associated manner;
an authentication control means for referring to the storage means and controlling the identity authentication using identity authentication information for authentication acquired from the user;
a specification means for specifying the entry qualification information associated with the identity authentication information with which the identity authentication has been successful;
an issuing means for issuing privilege information that is able to be used in one or more commercial facilities in a neighborhood of the event venue on the basis of the specified entry qualification information; and
a notification means for notifying the user of the issued privilege information.

A privilege information issuing system according to the present disclosure includes:
a storage apparatus; and
a privilege information issuing apparatus that is connected to the storage apparatus,
in which the privilege information issuing apparatus includes
a registration means for registering, in a storage means, entry qualification information with which a user is able to enter an event venue where an event is held through identity authentication and identity authentication information for registering the user who has purchased the entry qualification information in an associated manner,
an authentication control means for referring to the storage means and controlling the identity authentication using identity authentication information for authentication acquired from the user,
a specification means for specifying the entry qualification information associated with the identity authentication information with which the identity authentication has been successful,
an issuing means for issuing privilege information that is able to be used in one or more commercial facilities in a neighborhood of the event venue on the basis of the specified entry qualification information, and
a notification means for notifying the user of the issued privilege information.

A privilege information issuing method according to the present disclosure includes, by a computer:
registering, in a storage apparatus, entry qualification information with which a user is able to enter an event venue where an event is held through identity authentication and identity authentication information for registering the user who has purchased the entry qualification information in an associated manner;
referring to the storage apparatus and controlling the identity authentication using identity authentication information for authentication acquired from the user;
specifying the entry qualification information associated with the identity authentication information with which the identity authentication has been successful;
issuing privilege information that is able to be used in one or more commercial facilities in a neighborhood of the event venue on the basis of the specified entry qualification information; and
notifying the user of the issued privilege information.

A privilege information issuing program according to the present disclosure causes a computer to perform:
registration processing of registering, in a storage apparatus, entry qualification information with which a user is able to enter an event venue where an event is held through identity authentication and identity authentication information for registering the user who has purchased the entry qualification information in an associated manner;
authentication control processing of referring to the storage apparatus and controlling the identity authentication using identity authentication information for authentication acquired from the user;
specification processing of specifying the entry qualification information associated with the identity authentication information with which the identity authentication has been successful;
issuing processing of issuing privilege information that is able to be used in one or more commercial facilities in a neighborhood of the event venue on the basis of the specified entry qualification information; and
notification processing of notifying the user of the issued privilege information.

### Advantageous Effects of Invention

According to the present disclosure, it is possible to provide a privilege information issuing apparatus, a system, a method, and a program for encouraging a purchaser of entry qualification information for an event to use commercial facilities around an event venue.

### BRIEF DESCRIPTION OF DRAWINGS

FIG. 1 is a block diagram illustrating a configuration of a privilege information issuing apparatus according to a first example embodiment.

FIG. 2 is a flowchart illustrating a flow of a privilege information issuing method according to the first example embodiment.

FIG. 3 is a block diagram illustrating an overall configuration of a privilege information issuing system according to a second example embodiment.

FIG. 4 is a block diagram illustrating a configuration of an authentication apparatus according to the second example embodiment.

FIG. 5 is a block diagram illustrating a configuration of a user terminal according to the second example embodiment.

FIG. 6 is a block diagram illustrating a configuration of an entry control terminal according to the second example embodiment.

FIG. 7 is a block diagram illustrating a configuration of a payment terminal according to the second example embodiment.

FIG. 8 is a block diagram illustrating a configuration of a privilege information issuing apparatus according to the second example embodiment.

FIG. 9 is a flowchart illustrating a flow of member information registration processing according to the second example embodiment.

FIG. 10 is a flowchart illustrating a flow of face information registration processing performed by the authentication apparatus according to the second example embodiment.

FIG. 11 is a sequence diagram illustrating a flow of entry qualification information registration processing according to the second example embodiment.

FIG. 12 is a flowchart illustrating a flow of face authentication processing performed by the authentication apparatus according to the second example embodiment.

FIG. 13 is a sequence diagram illustrating a flow of privilege information issuing and utilization processing according to the second example embodiment.

FIG. 14 is a flowchart illustrating a flow of privilege information issuing processing according to the second example embodiment.

FIG. 15 is a diagram illustrating a display example of issued privilege information according to the second example embodiment.

FIG. 16 is a flowchart illustrating a flow of privilege information utilization processing according to the second example embodiment.

FIG. 17 is a diagram illustrating a display example of a result of payment using the privilege information according to the second example embodiment.

FIG. 18 is a diagram illustrating a display example of other issued privilege information according to the second example embodiment.

FIG. 19 is a flowchart illustrating a flow of privilege information issuing processing according to a third example embodiment.

FIG. 20 is a diagram illustrating a display example of issued privilege information according to the third example embodiment.

FIG. 21 is a block diagram illustrating an overall configuration of a privilege information issuing system according to a fourth example embodiment.

FIG. 22 is a flowchart illustrating a flow of privilege information issuing processing according to the fourth example embodiment.

FIG. 23 is a diagram illustrating a display example of issued privilege information according to the fourth example embodiment.

### EXAMPLE EMBODIMENT

Hereinafter, example embodiments of the present disclosure will be described in detail with reference to the drawings. In the drawings, the same or corresponding elements are denoted by the same reference numerals, and repeated descriptions will be omitted as necessary for clarity of description.

### First Example Embodiment

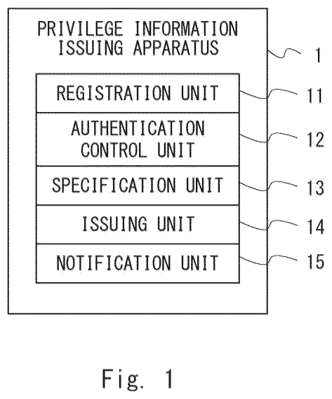

FIG. 1 is a block diagram illustrating a configuration of a privilege information issuing apparatus 1 according to a first example embodiment. The privilege information issuing apparatus 1 is an information processing apparatus that issues privilege information that can be used in predetermined commercial facilities. Here, the “commercial facilities” are stores that sell goods or provide services, accommodation facilities, public transportation stations, or the like. The commercial facilities according to the first embodiment are assumed to be present in a region within a predetermined range from an event venue where a predetermined event is held, that is, in the neighborhood of the event venue. In addition, the “privilege information” is electronic data to which a right to enjoy a paid privilege or a free privilege in an available facility has been given. The privilege information is, for example, value added information such as an electronic coupon or a point.

The privilege information issuing apparatus 1 includes a registration unit 11, an authentication control unit 12, a specification unit 13, an issuing unit 14, and a notification unit 15. The registration unit 11 registers entry qualification information and identity authentication information for registering a user who has purchased the entry qualification information in an associated manner in a storage apparatus. Note that the storage apparatus is built into the privilege information issuing apparatus 1 or is connected to the privilege information issuing apparatus 1. Here, the “entry qualification information” is information with which an entry scheduled person can enter the event venue where the event is held through identity authentication.

The authentication control unit 12 controls the identity authentication with reference to the storage apparatus using identity authentication information for authentication acquired from the user. Here, the “identity authentication” is information processing of verifying authenticity of an individual by collating identity authentication information registered in advance with information acquired from the individual or input from the individual at the time of the authentication and determining that a degree of matching is equal to or greater than a threshold value. Specifically, the authentication control unit 12 controls the identity authentication processing of collating the identity authentication information for registration registered in the storage apparatus with the identity authentication information for authentication. Although examples of the identity authentication include biometric authentication such as face authentication, collation of code information (such as an ID or a password) presented or input by the individual, and the like, the identity authentication is not limited thereto. The “identity authentication information” is information with which the identity can be identified and is face feature information, biometric information, code information, or the like of the person.

The specification unit 13 specifies entry qualification information associated with the identity authentication information with which the identity authentication has been successful. In other words, the specification unit 13 specifies the entry qualification information associated with the identity authentication information registered in the storage apparatus in a case where the identity authentication has been successful.

The issuing unit 14 issues privilege information that can be used in one or more commercial facilities in the neighborhood of the event venue on the basis of the specified entry qualification information. The notification unit 15 notifies the user of the issued privilege information. For example, the notification unit 15 notifies a user terminal carried by the user of the issued privilege information. Note that the notification destination of the privilege information is not limited to the user terminal and may be an authentication terminal as a request source of the identity authentication.

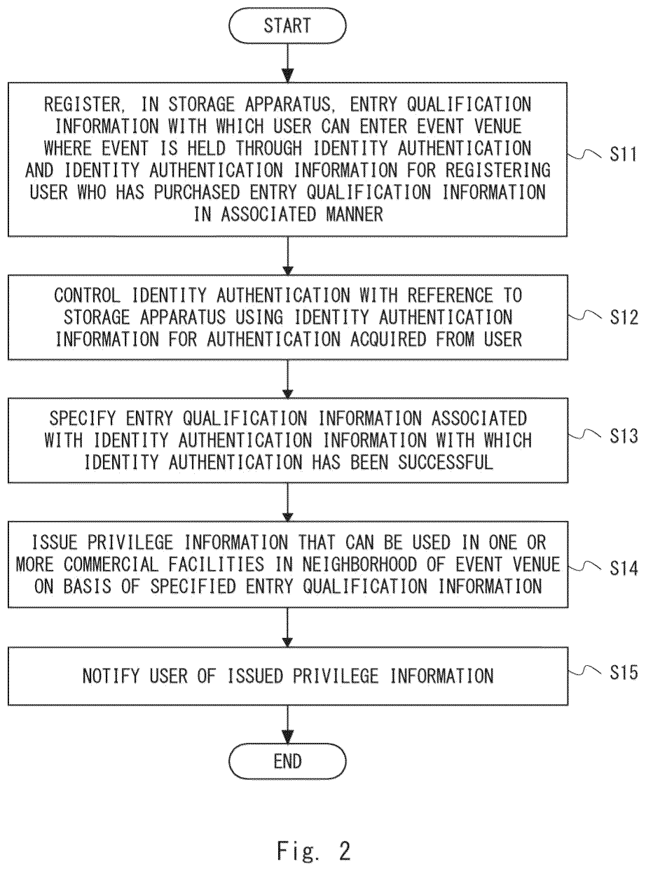

FIG. 2 is a flowchart illustrating a flow of privilege information issuing method according to the first example embodiment. First, the registration unit 11 registers, in the storage apparatus, the entry qualification information with which the user can enter the event venue where the event is held through identity authentication and the identity authentication information for registering the user who has purchased the entry qualification information in an associated manner (S11). Next, the authentication control unit 12 controls the identity authentication with reference to the storage apparatus using the identity authentication information for authentication acquired from the user (S12). Then, the specification unit 13 specifies the entry qualification information associated with the identity authentication information with which the identity authentication has been successful (S13). Then, the issuing unit 14 issues the privilege information that can be used in the one or more commercial facilities in the neighborhood of the event venue on the basis of the specified entry qualification information (S14). Thereafter, the notification unit 15 notifies the user of the issued privilege information (S15).

As described above, the privilege information that can be used in the commercial facilities around the event venue on the basis of the entry qualification information is issued for the purchaser of the entry qualification information with which the purchaser can enter the event venue through the identity authentication in the present example embodiment. In other words, the user can obtain privilege information for the commercial facilities in the surroundings as an incentive for the purchasing of the entry qualification information. Therefore, the user is motivated to use the commercial facilities around the event venue by the privilege information provided through the notification. It is thus possible to encourage the purchaser of the entry qualification information for the event to use the commercial facilities around the event venue.

Note that the privilege information issuing apparatus 1 includes a processor, a memory, and a storage apparatus as configurations, which are not illustrated. In addition, the storage apparatus stores a computer program that implements processing of the privilege information issuing method according to the present example embodiment. Then, the processor reads a computer program or the like from the storage apparatus into the memory and executes the computer program. In this manner, the processor realizes the functions of the registration unit 11, the authentication control unit 12, the specification unit 13, the issuing unit 14, and the notification unit 15.

Alternatively, each component of the privilege information issuing apparatus 1 may be implemented by dedicated hardware. In addition, some or all of the components of each apparatus may be implemented by general-purpose or dedicated circuitry, a processor, or a combination thereof. These may be configured of a single chip or may be configured of a plurality of chips connected via a bus. Some or all of the components of each apparatus may be implemented by a combination of the aforementioned circuitry or the like and a program. Furthermore, as the processor, a central processing unit (CPU), a graphics processing unit (GPU), a field-programmable gate array (FPGA), a quantum processor (quantum computer control chip), or the like can be used.

In a case where some or all of the components of the privilege information issuing apparatus 1 are implemented by a plurality of information processing apparatuses, circuits, or the like, the plurality of information processing apparatuses, circuits, or the like may be arranged in a centralized manner or in a distributed manner. For example, the information processing apparatuses, the circuits, or the like may be implemented in the form of a client server system, a cloud computing system, or the like in which they are connected to each other via a communication network. The functions of the privilege information issuing apparatus 1 may be provided in a software as a service (SaaS) format.

### Second Example Embodiment

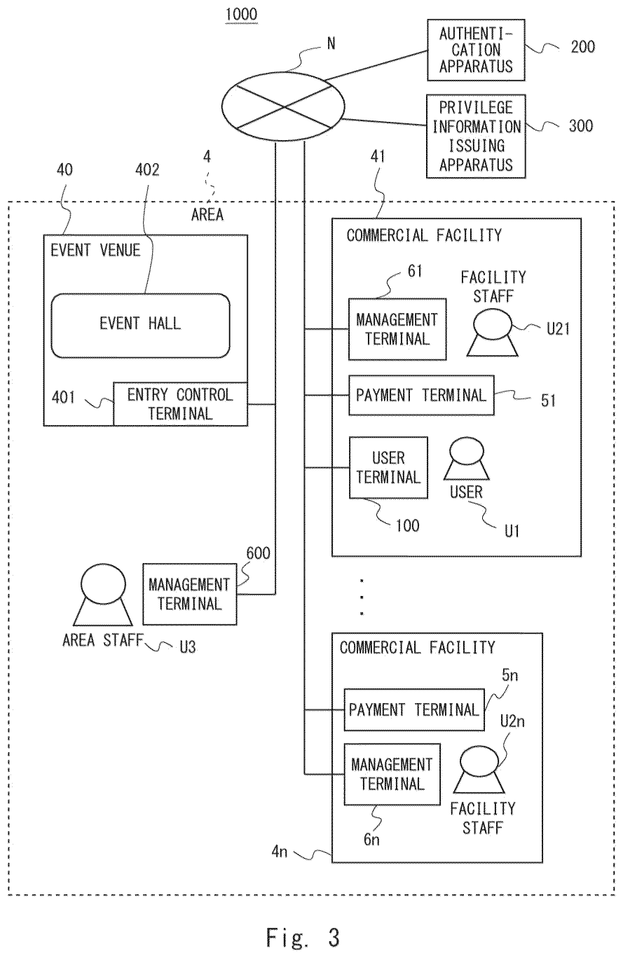

A second example embodiment is a specific example of the first example embodiment described above. FIG. 3 is a block diagram illustrating an overall configuration of a privilege information issuing system 1000 according to the second example embodiment. The privilege information issuing system 1000 is an information system that issues, for a user U1 who has purchased a paid electronic ticket (entry qualification information) for an event venue 40, a coupon that can be used also in a face authentication payment at a commercial facility 41 or the like in the neighborhood at the time of the payment in accordance with the entry qualification information. Also, privilege information with a time limit can promote a consumption action in the commercial facility 41 or the like in the neighborhood of the event venue 40. Therefore, it is possible to promote cooperative utilization of the event venue and the facilities and to support revitalization of the area 4 including the event venue 40 and the commercial facilities 41 to 4n (n is a natural number that is equal to or greater than one) in the neighborhood thereof.

The event venue 40 is a site where a predetermined event is held. The “event” is a paid service provided at a certain time by collecting a large number of people. For example, the event is a sport game, a concert, an exhibition, an international conference, or the like, and may be watched or viewed by paid visitors, or may be participated in by the visitors themselves. Therefore, the event venue 40 is a facility such as a sport stadium, a sport ground, an arena, a theater, or a multiuse event hall, for example. The event venue 40 can also be referred to as a main facility or a core facility in the area 4.

It is assumed that the event venue 40 includes an event hall 402 and an entry control terminal 401 is installed at an entrance. The entry control terminal 401 is an information terminal that permits entry to the event venue 40 in a case where the user U1 has succeeded in the person authentication. Details of the entry control terminal 401 will be described later. Note that some users entering the event venue 40 may enter without passing through the entry control terminal 401. In other words, the event venue 40 may allow users who have purchased conventional tickets or the like to enter without using identity authentication such as face authentication. The event hall 402 is a place where an event is held, a sport ground, an audience seat, or the like.

The commercial facilities 41 to 4n are facilities in the surroundings and commercial facilities in the neighborhood of the event venue 40. The number of commercial facilities 41 and the like may be at least one or more. The commercial facility 41 and the like are facilities in a cooperative relationship with the side of the event venue 40. Therefore, business operators of the commercial facility 41 and the like are business partners of a business operator on the side of the event venue 40. Examples of the commercial facility 41 and the like include, but are not limited to, retail stores, restaurants, shopping streets, shopping malls, accommodation facilities, parking lots, bicycle-parking lots, amusement parks, and transportation stations (railway stations, bus stops, taxi lanes, ports, airports).

In each of the commercial facilities 41 to 4n, at least each of payment terminals 51 to 5n compatible with the payment using face authentication is installed. In addition, each of the facility staff U21 to U2n performs a management operation such as registration and the like of privilege information that can be used in each of the commercial facilities 41 to 4n using each of management terminals 61 to 6n. The facility staff U21 and the like may also be shop staff of the commercial facility 41 and the like. Alternatively, the facility staff U21 and the like may be a cooperative business operator on the side of the commercial facility 41 and the like. Therefore, the facility staff U21 and the like and the management terminal 61 and the like may not necessarily be present inside the commercial facility 41 and the like.

An area staff U3 is a business operator who manages business operations inside the area 4 including the event venue 40, the commercial facility 41, and the like. The area staff U3 may register the privilege information that can be used in the commercial facility 41 and the like using the management terminal 600. Note that since it is possible to use known information processing apparatuses as the management terminals 61 to 6n and 600, illustration and detailed description will be omitted.

Here, the privilege information issuing system 1000 includes a user terminal 100, an authentication apparatus 200, a privilege information issuing apparatus 300, an entry control terminal 401, payment terminals 51 to 5n, and management terminals 61 to 6n and 600 the user terminal 100, the authentication apparatus 200, the privilege information issuing apparatus 300, the entry control terminal 401, the payment terminals 51 to 5n, and the management terminals 61 to 6n and 600 being communicatively connected via a network N. Here, the network N is a communication network including a wireless communication line and is, for example, the Internet, a wireless communication line network, a mobile phone line network, or the like. The network N may be of any type of communication protocol.

The authentication apparatus 200 is an information processing apparatus that manages face feature information of the user and performs face authentication. In response to a face authentication request received from the outside, the authentication apparatus 200 collates a face image or face feature information included in the request with the face feature information of each user, and returns the collation result (authentication result) to the request source.

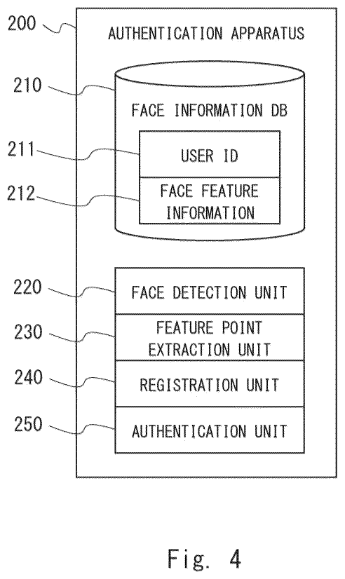

FIG. 4 is a block diagram illustrating the configuration of the authentication apparatus 200 according to the second example embodiment. The authentication apparatus 200 includes a face information database (DB) 210, a face detection unit 220, a feature point extraction unit 230, a registration unit 240, and an authentication unit 250. The face information DB 210 stores a user ID 211 and face feature information 212 of the user ID in association with each other. The face feature information 212 is a set of feature points extracted from the face image. Note that the authentication apparatus 200 may delete the face feature information 212 in the face information DB 210 in response to a request from the user or the like corresponding to the face feature information 212. Alternatively, the authentication apparatus 200 may delete the face feature information 212 after elapse of a predetermined period from registration.

The face detection unit 220 detects a face region included in a registered image for registering face information, and outputs the face region to the feature point extraction unit 230. The feature point extraction unit 230 extracts feature points from the face region detected by the face detection unit 220, and outputs the face feature information to the registration unit 240. In addition, the feature point extraction unit 230 extracts feature points included in the face image received from the privilege information issuing apparatus 300 or the like, and outputs the face feature information to the authentication unit 250.

The registration unit 240 newly issues the user ID 211 at a time of registering the face feature information. The registration unit 240 registers the issued user ID 211 and the face feature information 212 extracted from the registered image in the face information DB 210 in association with each other. The authentication unit 250 performs face authentication using the face feature information 212. Specifically, the authentication unit 250 collates the face feature information extracted from the face image with the face feature information 212 in the face information DB 210. If the collation is successful, the authentication unit 250 specifies the user ID 211 associated with the collated face feature information 212. The authentication unit 250 returns the matching result of the face feature information to the request source as a face authentication result. Whether or not the pieces of face feature information match each other corresponds to whether or not authentication has been successful or failed. Note that the fact that the pieces of face feature information match each other refers to the case where the degree of matching is equal to or greater than a threshold value. In addition, it is assumed that the face authentication result includes the specified user ID if the face authentication has been successful.

Returning to FIG. 3, the description will be continued. The user U1 carries the user terminal 100 with himself/herself, operates the user terminal 100, is a purchaser of entry qualification information of an event that is held in the event venue 40, and is an entry scheduled person, a visitor, or a leaving person. Here, the “entry qualification information” is information proving that the user can enter the event venue through identity authentication.

The user terminal 100 is an information processing terminal that registers user information including the face image and the entry qualification information in the privilege information issuing apparatus 300 in advance in accordance with an operation of the user U1. Note that the user U1 may perform registration and the like of the user information using an information processing apparatus other than the user terminal 100. Furthermore, it is assumed that the user U1 enters the event venue 40 with the user terminal 100 carried with the user. Note that although the user U1 and the user terminal 100 are present inside the commercial facility 41 in FIG. 3, the location of presence is not limited thereto.

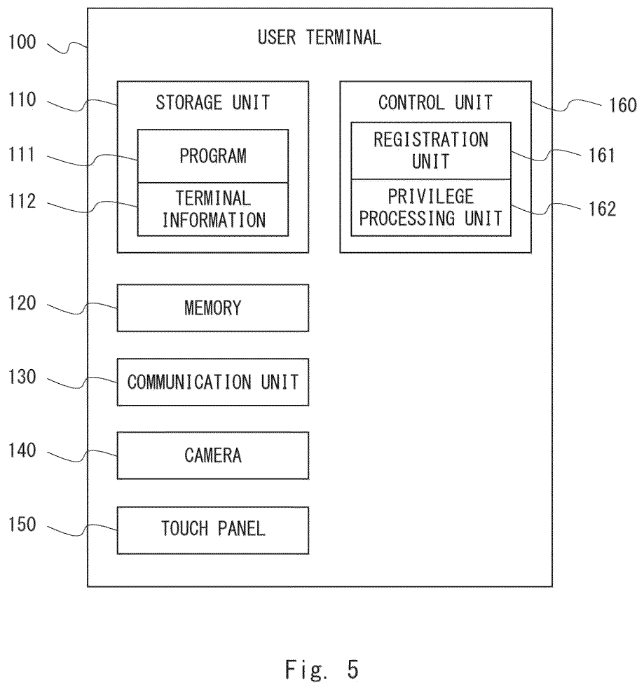

FIG. 5 is a block diagram illustrating a configuration of the user terminal 100 according to the second example embodiment. The user terminal 100 includes a storage unit 110, a memory 120, a communication unit 130, a camera 140, a touch panel 150, and a control unit 160. The storage unit 110 is an example of a nonvolatile storage device such as a flash memory. The storage unit 110 stores a program 111 and terminal information 112. The program 111 is a computer program in which processing such as registration of user information and entry qualification information, and inquiry, display, selection, and utilization of privilege information are mounted. The terminal information 112 is identification information and destination information of the user terminal 100.

The memory 120 is a volatile storage device such as a random access memory (RAM) and is a storage region for temporarily holding information during an operation of the control unit 160. The communication unit 130 is a communication interface with the network N.

The camera 140 is an imaging apparatus for imaging a region including the face of the user U1. The camera 140 outputs the captured image to the control unit 160. The touch panel 150 includes a display apparatus (display unit) such as a screen and an input apparatus.

The control unit 160 is a processor, that is, a control apparatus, that controls each configuration of the user terminal 100. The control unit 160 reads the program 111 from the storage unit 110 into the memory 120 and executes the program 111. In this manner, the control unit 160 implements the functions of the registration unit 161 and the privilege processing unit 162.

The registration unit 161 controls the camera 140, images the face of the user U1, and acquires the captured face image. Also, the registration unit 161 acquires attribute information and payment information input by the user U1 via the touch panel 150. In addition, the registration unit 161 reads and acquires the terminal information 112 from the storage unit 110. Then, the registration unit 161 transmits a registration request of the user information (member information) including the face image, the terminal information 112, the attribute information, and the payment information to the privilege information issuing apparatus 300. Furthermore, the registration unit 161 acquires entry qualification information purchased by the user U1. The registration unit 161 transmits a registration request including the face image of the user U1 and the entry qualification information to the privilege information issuing apparatus 300. Note that the registration unit 161 may include the entry qualification information in the registration request of the user information.

In a case where the privilege processing unit 162 receives a notification of privilege information issued by the privilege information issuing apparatus 300 at the time of face authentication payment at the commercial facility 41, the privilege processing unit 162 displays, on the touch panel 150, the privilege information provided through the notification and payment prices and the like before and after utilization of the privilege information. Furthermore, in a case where the payment has been made using the privilege information, the privilege processing unit 162 receives a payment completion and privilege information utilization notification and displays a payment result and a privilege information utilization result on the touch panel 150.

Also, the privilege processing unit 162 may perform the following processing. For example, the privilege processing unit 162 controls the camera 140 such that the face of the user U1 is imaged in response to a privilege issuing request provided through an instruction from the user U1 via the touch panel 150 and acquires the captured face image. At this time, the privilege processing unit 162 reads and acquires the terminal information 112 from the storage unit 110. Then, the privilege processing unit 162 transmits a privilege issuing request including the face image and the terminal information 112 to the privilege information issuing apparatus 300. Also, in a case where the privilege processing unit 162 receives a notification of privilege information issued from the privilege information issuing apparatus 300, the privilege processing unit 162 displays the privilege information and the like provided through the notification on the touch panel 150. In addition, the privilege processing unit 162 transmits a privilege information inquiry request including the face image of the user U1 to the privilege information issuing apparatus 300 in response to the privilege inquiry request provided through an instruction from the user U1 via the touch panel 150. Then, the privilege processing unit 162 displays, on the touch panel 150, a list of the privilege information that has already been issued from the privilege information issuing apparatus 300 for the user U1. The privilege processing unit 162 displays the privilege information selected by the user U1 via the touch panel 150 in a selected state. In a case where the privilege processing unit 162 receives a privilege information update notification from the privilege information issuing apparatus 300, the privilege processing unit 162 displays the privilege information after update on the touch panel 150.

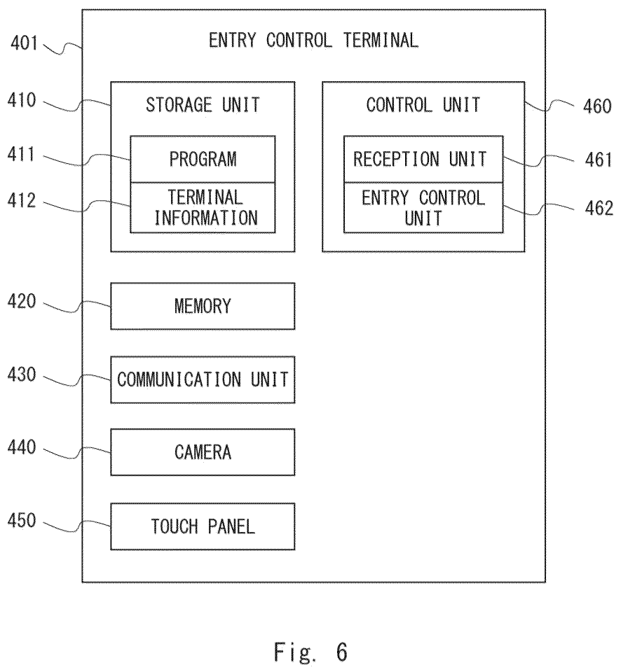

FIG. 6 is a block diagram illustrating a configuration of the entry control terminal 401 according to the second example embodiment. The entry control terminal 401 includes a storage unit 410, a memory 420, a communication unit 430, a camera 440, a touch panel 450, and a control unit 460. The storage unit 410 is an example of a nonvolatile storage device such as a flash memory. The storage unit 410 stores a program 411 and terminal information 412. The program 411 is a computer program in which the entry control processing and the like are mounted. The terminal information 412 is identification information and destination information of the entry control terminal 401.

The memory 420 is a volatile storage device such as a RAM, and is a storage region for temporarily holding information during operations of the control unit 460. The communication unit 430 is a communication interface with the network N.

The camera 440 is an imaging apparatus for imaging a region including a face of an entry scheduled person such as the user U1. The camera 440 outputs the captured image to the control unit 460. The touch panel 450 includes a display apparatus (display unit) such as a screen and an input apparatus.

The control unit 460 is a processor, that is, a control apparatus that controls each configuration of the entry control terminal 401. The control unit 460 reads the program 411 from the storage unit 410 into the memory 420 and executes the program 411. In this manner, the control unit 460 implements the functions of the reception unit 461 and the entry control unit 462.

The reception unit 461 receives the face image of the entry scheduled person captured by the camera 440 and outputs the face image to the entry control unit 462. The entry control unit 462 transmits an entry determination request including the face image output by the reception unit 461 and the terminal information 412 stored in the storage unit 110 to the privilege information issuing apparatus 300. Then, in a case where the entry control unit 462 receives an entry determination result from the privilege information issuing apparatus 300 and the entry determination result indicates permission of entry, the entry control unit 462 performs control to unlock an entrance gate (not illustrated) or the like of the event venue 40. Note that entry control terminal 401 may control an exit gate through face authentication at the time of exiting the site as well.

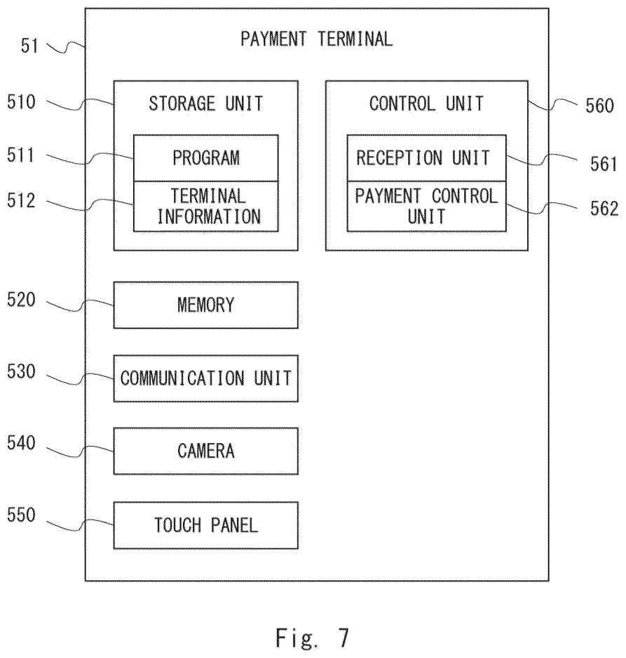

FIG. 7 is a block diagram illustrating a configuration of the payment terminal 51 according to the second example embodiment. Note that since the configurations of the payment terminal 5n and the like are similar to that of the payment terminal 51, illustration and detailed description will be omitted. The payment terminal 51 includes a storage unit 510, a memory 520, a communication unit 530, a camera 540, a touch panel 550, and a control unit 560. The storage unit 510 is an example of a nonvolatile storage device such as a flash memory. The storage unit 510 stores a program 511 and terminal information 512. The program 511 is a computer program in which payment control processing and the like are mounted. The terminal information 512 is identification information and destination information of the payment terminal 51. In addition, the terminal information 512 is assumed to be information with which the commercial facility 41 where the terminal is installed can be specified.

The memory 520 is a volatile storage device such as a RAM, and is a storage region for temporarily holding information during the operations of the control unit 560. The communication unit 530 is a communication interface with the network N.

The camera 540 is an imaging apparatus for imaging a region including a face of a person who makes payment such as the user U1. The camera 540 outputs the captured image to the control unit 560. The touch panel 550 includes a display apparatus (display unit) such as a screen and an input apparatus.

The control unit 560 is a processor, that is, a control apparatus that controls each configuration of the payment terminal 51. The control unit 560 reads the program 511 from the storage unit 510 into the memory 520 and executes the program 511. In this manner, the control unit 560 implements the functions of the reception unit 561 and the payment control unit 562.

The reception unit 561 receives an input of payment target information such as a price of a product for the person who makes payment will make a payment for. For example, the reception unit 561 receives, as payment target information, information read from a barcode on a product with a scanner (not illustrated) by a store staff (for example, the facility staff U21 or the like) of the commercial facility 41. Then, the reception unit 561 displays the received payment target information on the touch panel 550.

Subsequently, the payment control unit 562 controls the camera 540 to image the face of the person who has made payment and acquires the captured face image. Then, the payment control unit 562 transmits a face authentication payment request including the face image, the payment target information, and the terminal information 512 stored in the storage unit 510 to the privilege information issuing apparatus 300. Note that the payment target information may include a payment ID for identifying the payment processing. Then, the payment control unit 562 receives a payment completion notification or the like, and displays the payment completion notification or the like on the touch panel 550.

Furthermore, the payment control unit 562 images code information of the privilege information displayed on the user terminal 100 with the camera 540, analyzes the captured image, and extracts the privilege ID and the payment ID. Then, the payment control unit 562 transmits a privilege information utilization request including the extracted privilege ID and payment ID and the terminal information 512 stored in the storage unit 510 to the privilege information issuing apparatus 300. Then, the payment control unit 562 receives a payment completion and privilege information utilization notification and displays a payment result and a privilege information utilization result on the touch panel 550.

Note that in a case where the payment ID and the user ID are not extracted although the privilege ID is extracted (recognized) if the image obtained by imaging the code information is analyzed, the payment control unit 562 subsequently controls the camera 540 to image the face of the person who has made payment and acquires the captured face image. Then, the payment control unit 562 may transmit a face authentication payment request including the face image, the payment target information, the privilege ID, and the terminal information 512 stored in the storage unit 510 to the privilege information issuing apparatus 300.

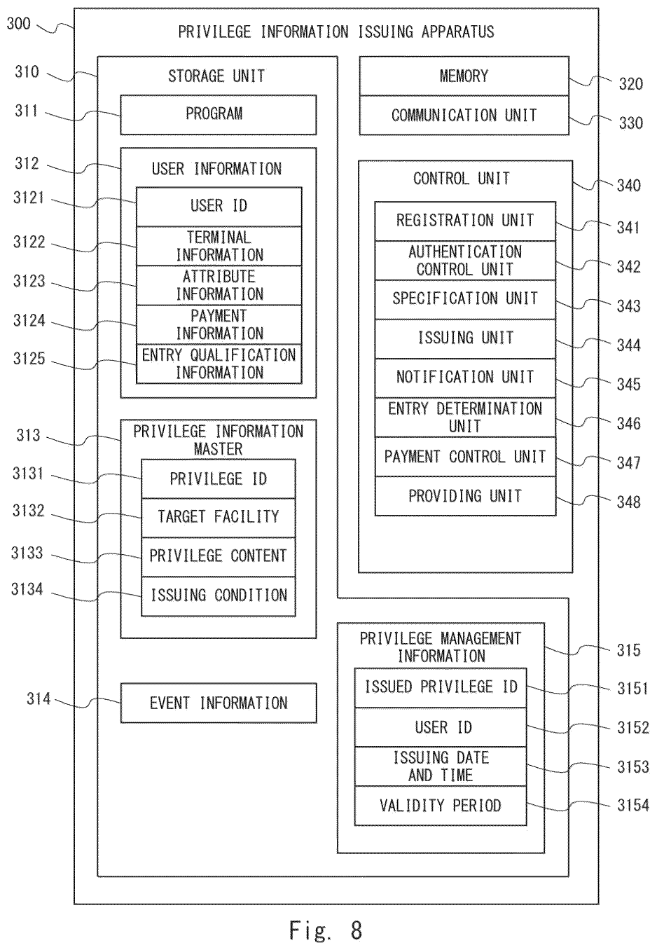

FIG. 8 is a block diagram illustrating a configuration of the privilege information issuing apparatus 300 according to the second example embodiment. The privilege information issuing apparatus 300 is an example of the aforementioned privilege information issuing apparatus 1. The privilege information issuing apparatus 300 is an information processing apparatus for issuing privilege information that can be used in a commercial facility 41 and the like around the event venue 40 for the user who has the entry qualification information for the event venue 40. In addition, the privilege information issuing apparatus 300 performs payment processing in the commercial facility 41 or the like in response to the face authentication payment request from the payment terminal 51. In a case where the user who has succeeded in the face authentication has the entry qualification information for the event venue 40, in particular, the privilege information issuing apparatus 300 issues the privilege information that can be used in the commercial facility 41 or the like around the event venue 40 for the user on the basis of the entry qualification information before execution of the payment processing. Furthermore, in a case where a utilization request of the issued privilege information is received, the privilege information issuing apparatus 300 performs the payment processing using the privilege information. The privilege information issuing apparatus 300 may be made redundant across a plurality of serves, and each functional block may be implemented by a plurality of computers.

The privilege information issuing apparatus 300 includes a storage unit 310, a memory 320, a communication unit 330, and a control unit 340. The storage unit 310 is an example of a nonvolatile storage device such as a hard disk or a flash memory. The storage unit 310 stores a program 311, user information 312, a privilege information master 313, event information 314, and privilege management information 315. Note that the storage unit 310 and the face information DB 210 of the authentication apparatus 200 may be regarded as a storage apparatus that stores the entry qualification information, the identity authentication information of the user who has purchased the entry qualification information, and the terminal that the user carries with himself/herself in an associated manner. The program 311 is a computer program (privilege information issuing program) in which processing of registering the privilege information, the user information, and the entry qualification information, the privilege information issuing processing, the payment processing including the privilege information utilization processing, and the like according to the second example embodiment are implemented.

The user information 312 is information for managing users in the area 4. Note that “users in area 4” are, for example, purchasers of the entry qualification information of the event venue 40, entry scheduled persons who are scheduled to enter the event venue 40, entering persons, and persons exiting the event venue 40. The user information 312 is information in which a user ID 3121, terminal information 3122, attribute information 3123, payment information 3124, and entry qualification information 3125 are associated.

The user ID 3121 is identification information of the user. The user ID 3121 is information that is the same as or uniquely corresponds to the user ID 211 managed in association with the face feature information 212 in the face information DB 210 of the authentication apparatus 200. Therefore, it is possible to state that the user information 312 is information associated with the identity authentication information for registration of the user via the user ID 3121. The terminal information 3122 is information corresponding to the terminal information 112 of the user terminal 100 described above.

Examples of the attribute information 3123 include, but are not limited to, a name, a date of birth, a sex, an address, a contact (a telephone number, an e-mail address, account information of a social networking service (SNS)), a member rank, information indicating a hobby, preference, or interest, a support target of an athlete or a team, and the like. Note that the member rank may be, for example, information indicating a rank or the like in members who have made payment in the event venue 40, a rank in another member service, or the like.

The payment information 3124 is credit card information, electronic money, barcode payment account information, bank withdrawal account information, or the like, and is also information used for payment using face authentication (face authentication payment).

The entry qualification information 3125 is paid digital entry ticket information for a predetermined event held in the event venue 40 on a date and time of the event. The entry qualification information 3125 may include, for example, an event ID, seat information (a seat position and a seat grade), a ticket price, and the like. Furthermore, the entry qualification information 3125 may include identification information of the event venue, an entry time zone, an event content, and the like, instead of the event ID. Also, it is possible to state that the entry qualification information 3125 according to the present example embodiment is proof information indicating that the user has the qualification of permission to enter the event venue 40 on the basis of success in the face authentication.

Note that a purchase history of the entry qualification information 3125 in past events may be further registered in association with user ID 3121 in the user information 312.

The privilege information master 313 is information for managing master information of the privilege information input by facility staff or the area staff. The privilege information master 313 is information in which a privilege ID 3131, a target facility 3132, a privilege content 3133, and an issuing condition 3134 are associated. The privilege ID 3131 is identification information of privilege information. The target facility 3132 is information indicating a facility where the privilege information can be used. The target facility 3132 is, for example, information indicating any of the commercial facilities 41 to 4n. Note that the target facility 3132 may be targeted to two or more facilities among the commercial facilities 41 to 4n.

The privilege content 3133 is information indicating a product or a service that the user can enjoy by being used in the facility. Examples of the privilege content 3133 include, but are not limited to, discount information indicating a discount price or a discount rate, a discount target product or service, a free product or service, and the like.

The issuing condition 3134 is information indicating a condition for issuing the privilege information. Examples of the issuing condition 3134 include event information (an event ID, date and time, and the like) to be issued, the fact that entry qualification information of the event information has already been purchased, and an issuing timing. The issuing timing is an issuing start date and time, an issuable period, or the like. In addition, examples of the issuing condition 3134 include, but are not limited to, attribute information of the user as a target of issuing, a seat grade, a ticket price, a priority order of attribute information prioritizing issuance, and the like.

The event information 314 is information defining an event held at the event venue 40. The event information 314 includes, for example, an event ID, a venue, event hour information, event contents, seat information (a seat type, a seat number, and arrangement), a price of the entry qualification information (ticket price), and the like. Note that examples of the event hour information include, but are not limited to, an event period, a start date and time, a scheduled start time, a scheduled end time, an entry time zone, an entry start time, and the like.

The privilege management information 315 is information for managing the privilege information issued for the user. The privilege management information 315 is information in which an issued privilege ID 3151, a user ID 3152, an issuing date and time 3153, and a validity period 3154 are associated.

The issued privilege ID 3151 is the privilege ID 3131 issued for the user corresponding to the user ID 3152. The user ID 3152 is the user ID 3121 for which the privilege information has been issued. Therefore, the privilege management information 315 is, for example, information uniquely specified by a set of the issued privilege ID 3151 and the user ID 3152. The issuing date and time 3153 is a date and time on which the privilege information has been issued. The validity period 3154 is a period in which the privilege according to the privilege information can be enjoyed (the privilege information is valid). The validity period 3154 is defined by a start date and time and an end date and time (effective period). In a case where the corresponding privilege information can be used immediately after the issuing, a date and time of the effective period may be set as the validity period 3154.

The memory 320 is a volatile storage device such as a RAM, and is a storage region for temporarily holding information during the operations of the control unit 340. The communication unit 330 is a communication interface with the network N.

The control unit 340 is a processor, that is, a control apparatus that controls each configuration of the privilege information issuing apparatus 300. The control unit 340 reads the program 311 from the storage unit 310 into the memory 320 and executes the program 311. In this manner, the control unit 340 implements functions of a registration unit 341, an authentication control unit 342, a specification unit 343, an issuing unit 344, a notification unit 345, an entry determination unit 346, a payment control unit 347, and a providing unit 348. Note that the registration unit 341 is an example of the registration unit 11 described above. The authentication control unit 342 is an example of the authentication control unit 12 described above. The specification unit 343 is an example of the specification unit 13 described above. The specification unit 343 and the issuing unit 344 are examples of the issuing unit 14 described above. Also, the specification unit 343 and the notification unit 345 are examples of the notification unit 15 described above.

The registration unit 341 performs registration processing and the like of the privilege information, the user information, and the entry qualification information. Specifically, the registration unit 341 receives a registration request of individual privilege information from the management terminal 61 or the like and registers the privilege information in the privilege information master 313. At this time, the registration unit 341 issues a privilege ID for the new privilege information. Furthermore, the registration unit 341 receives a registration request of the user information from the user terminal 100 or the like, and registers the registration request in the user information 312. At this time, the registration unit 341 registers face feature information based on a face image for a new user in the authentication apparatus 200, and acquires a user ID issued at the time of the registration. Then, the registration unit 341 registers the acquired user ID 3121 and the information (the terminal information, the attribute information, the payment information, and the like) included in the registration request in an associated manner as user information 312 in the storage unit 310. The registration unit 341 registers, in the storage unit 310, identity authentication information for registration of the user and terminal information possessed by the user in association with each other. The registration unit 341 according to the present example embodiment registers, in the storage unit 310, the user ID 3121 uniquely corresponding to the face feature information for registration of the user, the terminal information 3122, the attribute information 3123, and the payment information 3124 as the user information 312. Furthermore, the registration unit 341 receives a registration request including the face image and the entry qualification information, associates the entry qualification information 3125 with the user information 312 specified by the face authentication based on the face image, and updates the user information 312. Note that the registration unit 341 may associate the payment history of the user U1 inside the event venue 40 and in the commercial facility 41 and the like with the user ID 3121 and update the user information 312. The payment history may include a purchase history of the entry qualification information 3125 in the past events.

The authentication control unit 342 controls identity authentication of the user using the authentication apparatus 200. In particular, the authentication control unit 342 according to the present example embodiment controls biometric authentication of the user using biometric information extracted from an image obtained by imaging the user. Specifically, the authentication control unit 342 controls the face authentication of the user using the face feature information extracted from the face image of the user. In other words, in a case where the authentication control unit 342 receives the identity authentication information for authentication of the user and the entry qualification information, the authentication control unit controls the identity authentication with reference to the storage unit 310 and the face information DB 210 of the authentication apparatus 200 using the identity authentication information for authentication. In addition, in a case where the authentication control unit 342 receives a privilege issuing request including the face image or a privilege information inquiry request from the user terminal 100, the authentication control unit 342 transmits a face authentication request including the face image included in the request to the authentication apparatus 200 and receives a face authentication result from the authentication apparatus 200. Then, the authentication control unit 342 outputs the face authentication result to the specification unit 343 and the issuing unit 344. Also, in a case where the authentication control unit 342 receives an entry determination request from the entry control terminal 401, the authentication control unit 342 transmits a face authentication request including the face image included in the entry determination request to the authentication apparatus 200, receives a face authentication result from the authentication apparatus 200, and outputs the face authentication result to the entry determination unit 346. Also, in a case where the authentication control unit 342 receives a face authentication payment request from the payment terminal 51 or the like, the authentication control unit 342 transmits a face authentication request including the face image included in the face authentication payment request to the authentication apparatus 200, receives a face authentication result from the authentication apparatus 200, and outputs the face authentication result to the payment control unit 347. In other words, the authentication control unit 342 controls the identity authentication if the user makes payment at the commercial facility (at a time of payment by the user in the commercial facilities). Note that the authentication control unit 342 may control the identity authentication other than the biometric authentication.

The specification unit 343 specifies the terminal information, the attribute information, the payment information, the entry qualification information, and the privilege information of the user on the basis of the identity authentication for the user. Specifically, in a case where the face authentication performed by the authentication control unit 342 has been successful, the specification unit 343 specifies the user ID included in the face authentication result. Then, the specification unit 343 specifies the terminal information 3122, the attribute information 3123, the payment information 3124, and the entry qualification information 3125 associated with the specified user ID 3121 from the user information 312. Moreover, the specification unit 343 may specify corresponding event information 314 from the entry qualification information 3125. In particular, the specification unit 343 determines whether or not there is entry qualification information 3125 associated with the user ID 3121 of the user who has succeeded in the face authentication from the user information 312. In a case where it is determined that the entry qualification information is present, the specification unit 343 determines whether or not the entry qualification information 3125 satisfies a privilege information issuing condition. Specifically, the specification unit 343 determines whether or not event information as a target of issuing defined by the issuing condition 3134 includes the event corresponding to the entry qualification information determined to be present from the privilege information master 313. In a case where the event information as a target of issuing includes the entry qualification information associated with the user ID of the user who has succeeded in the face authentication, the specification unit 343 determines that the entry qualification information satisfies the privilege information issuing condition and specifies the entry qualification information.

Moreover, the specification unit 343 may specify seat information included in the specified entry qualification information 3125. Furthermore, the specification unit 343 may specify the purchase history of the entry qualification information of the events including the entry qualification information 3125 associated with the user ID 3121 of the user who has succeeded in the face authentication. Also, the specification unit 343 specifies the privilege ID included in the privilege information utilization request and specifies the privilege information associated with the user ID 3152 of the user who has succeeded in the face authentication and the issued privilege ID 3151 from the privilege management information 315. Furthermore, the specification unit 343 specifies a payment ID included in the privilege information utilization request and specifies payment target information corresponding to the payment ID. In addition, the specification unit 343 specifies a list of privilege information associated with the user ID 3152 of the user who has succeeded in the face authentication from the privilege management information 315 in response to a privilege information inquiry request. Furthermore, the specification unit 343 specifies the issued privilege ID 3151 included in the face authentication payment request, and specifies the privilege information associated with the user ID 3152 of the user who has succeeded in the face authentication and the issued privilege ID 3151 from the privilege management information 315. Also, the specification unit 343 specifies the payment information 3124 associated with the user ID 3121 of the user who has succeeded in the face authentication from the user information 312.

The issuing unit 344 issues privilege information that can be used in one or more commercial facilities in the neighborhood of the event venue on the basis of the specified entry qualification information. In other words, in a case where the entry qualification information associated with the user ID of the user who has succeeded in the face authentication is specified as satisfying the privilege information issuing condition, the issuing unit 344 issues privilege information that can be used in the commercial facilities. In particular, the issuing unit 344 issues the privilege information that can be used in the commercial facility at the time of payment on the basis of the specified entry qualification information. In this manner, the user can enjoy the privilege by immediately using the issued privilege information. Furthermore, it is only necessary for the issuing unit 344 to issue the privilege information including discount information that can be applied to a payment price at the time of payment on the basis of the entry qualification information. In this manner, the user can get discount from the payment price at the time of this payment by immediately using the issued privilege information. Also, the issuing unit 344 may issue privilege information in accordance with specified seat information. In a case where the grade of the seat in the event venue 40 is high, for example, a privilege that is better than usual may be granted. Also, the issuing unit 344 may issue privilege information in accordance with the specified purchase history. Furthermore, the issuing unit 344 may issue the privilege information on the basis of the specified attribute information as well.

The notification unit 345 notifies the user terminal 100 of the user U1 of the privilege information issued by the issuing unit 344. For example, in a case where face authentication in response to the privilege issuing request has been successful, the entry qualification information has been acquired, and the privilege information has been issued, the notification unit 345 specifies the terminal information 3122 associated with the user ID 3121. Then, the notification unit 345 notifies the user terminal 100 regarded as a destination from the specified terminal information 3122 of the privilege information. In addition, in a case where the payment control unit 347 completes the payment processing, the notification unit 345 transmits a payment completion notification to the payment terminal corresponding to the terminal information included in the face authentication payment request. In addition, in a case where the payment control unit 347 completes the payment processing using the privilege information, a payment completion and privilege information utilization notification is transmitted to the user terminal 100 of the user U1 and the payment terminal.

The entry determination unit 346 determines whether or not the face authentication result based on the entry determination request received from the entry control terminal 401 indicates that the face authentication has been successful, and transmits the entry determination result to the entry control terminal 401. The entry determination unit 346 includes an indication of permission of entry in the entry determination result in a case of the user who has succeeded in the face authentication and has entry qualification information registered, or the entry determination unit 346 includes an indication of non-permission of entry in the entry determination result in a case where the user has failed the face authentication. Note that, in a case where the face authentication has been successful, the entry determination unit 346 may perform registration in the user information 312 such that completion of entry of the user who has succeeded in the face authentication can be identified. For example, the entry determination unit 346 may register an entry state flag indicating “completion of entry” or the date and time of entry in the entry qualification information 3125 associated with the user ID 3121 of the user who has succeeded in the face authentication. Note that the entry determination unit 346 may update the entry state flag to “completion of exiting” in a case where exiting of the user is detected through face authentication or the like.

In a case where the face authentication based on the face authentication payment request received from the payment terminal 51 or the like has been successful, the payment control unit 347 controls the payment processing. Specifically, the payment control unit 347 performs the payment processing using the payment information 3124 associated with the user ID 3121 of the user who has succeeded in the face authentication. In a case where the privilege ID is included in the privilege information use request received from the payment terminal 51 or the like, in particular, the payment control unit 347 performs the payment processing using the privilege information corresponding to the privilege ID. Alternatively, in a case where the privilege ID is included in the face authentication payment request, the payment control unit 347 determines whether or not the privilege information corresponding to the privilege ID can be used, and in a case where the privilege information can be used, the payment control unit 347 performs the payment processing using the privilege information.

Specifically, in these cases, the payment control unit 347 specifies the facility from the terminal information included in the received face authentication payment request and specifies the target facility 3132 associated with the privilege ID (the issued privilege ID 3151, the privilege ID 3131) included in the face authentication payment request. In a case where the specified facility is included in the target facility 3132, the payment control unit 347 determines that the privilege information can be used. Furthermore, in a case where the utilization state flag and the like are included in the privilege management information 315, the payment control unit 347 may determine the availability in consideration of the utilization state flag and the like.

Then, in a case where the privilege information can be used, the payment control unit 347 specifies the payment information 3124 associated with the specified user ID 3121 from the user information 312. Then, the payment control unit 347 specifies the issued privilege ID 3151 associated with the specified user ID 3152 from the privilege management information 315 and specifies the privilege content 3133 associated with the issued privilege ID 3151 as the privilege ID 3131 from the privilege information master 313. Then, the payment control unit 347 applies the specified privilege content 3133 to the price of the payment target information included in the face authentication payment request and calculates a payment price. In a case where the privilege content 3133 is “lunch set 10% off”, for example, the payment control unit 347 calculates a price obtained by discounting 10% from the price of the payment target information as the payment price. Then, the payment control unit 347 transmits an instruction for withdrawing the payment price to a payment server (not illustrated) using the specified payment information 3124 and receives a payment result. Note that the payment server is a known server operated by a financial institution or the like and illustration and detailed description thereof will thus be omitted. Also, in a case where the privilege content 3133 is “one drink for free” and a drink is included in the payment target information, the payment control unit 347 subtracts the price of one glass of drink from the price of the payment target information and calculates the payment price.

On the other hand, in a case where the privilege information cannot be used, the payment control unit 347 performs the payment processing without using the privilege information. In other words, the payment control unit 347 performs the payment processing for the payment target information using the payment information of the specified user ID.

In a case where the user makes payment using the privilege information issued through the identity authentication in the commercial facility, the providing unit 348 provides information related to the user associated with the user ID of the user who has succeeded in the identity authentication to the commercial facility. For example, the providing unit 348 transmits the information related to the user to the management terminal 61 or the like that manages the commercial facility 41 or the like where the payment has been made or the management terminal 600 that manages the area 4. Also, examples of the “information related to the user” include attribute information, a price of entry qualification information, a grade of a seat, and a purchase history (total number of purchases, a total purchase price, and the like). The store side can thus analyze what kinds of store visitors have used the privilege information. For example, the store side can analyze whether the user has a lot of event watching histories while the purchased ticket price is relatively reasonable or whether the user has a small number of event watching histories while the purchased ticket price is relatively expensive. The store side can review their service and the privilege information in accordance with such feedback.

Here, a flow of registration of the privilege information will be described. Here, an example in which the facility staff U21 registers privilege information of the commercial facility 41 will be described. First, the management terminal 61 receives inputs of privilege content that can be used in the commercial facility 41, an issuing condition, and a target facility from the facility staff U21. The issuing conditions include event information that is a target of issuing. The target facility is the commercial facility 41. Then, the management terminal 61 transmits a privilege information master registration request including the received privilege content, issuing condition, and target facility to the privilege information issuing apparatus 300 via the network N. In response to the request, the privilege information issuing apparatus 300 issues the privilege ID corresponding to the privilege content included in the received privilege information master registration request and registers the issued privilege ID 3131, the target facility 3132 included in the request, the privilege content 3133, and the issuing condition 3134 in an associated manner as the privilege information master 313 in the storage unit 310. Similarly, the facility staff U2n registers privilege information related to the commercial facility 4n. Note that the area staff U3 may register the privilege information of the commercial facility 41 and the like using the management terminal 600. In addition, the facility staff U21 to U2n, the area staff U3, and the like may update the privilege content, the issuing conditions, and the target facilities in the privilege information that has already been registered.

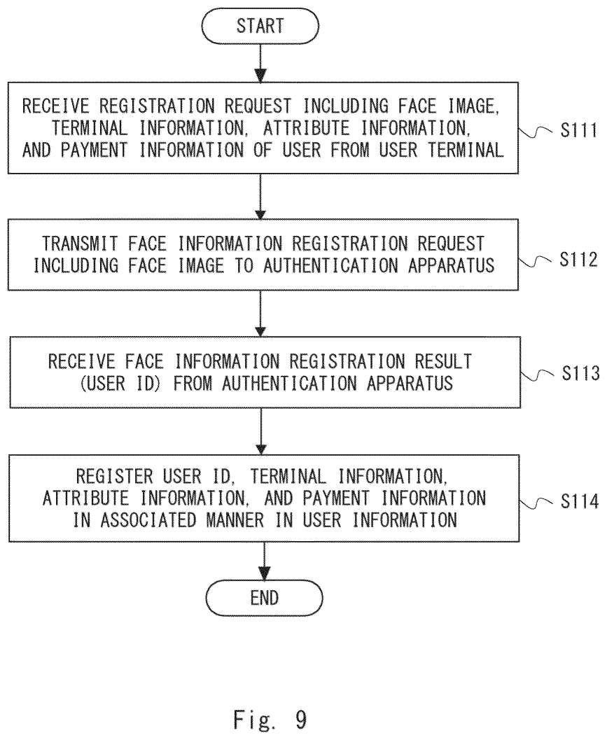

FIG. 9 is a flowchart illustrating a flow of member information registration processing according to the second example embodiment. First, the privilege information issuing apparatus 300 receives a registration request including a face image, terminal information, attribute information, and payment information of the user U1 from the user terminal 100 via the network N (S111). Then, the privilege information issuing apparatus 300 transmits a face information registration request including the face image to the authentication apparatus 200 via the network N (S112). In response to the transmission, the authentication apparatus 200 performs face information registration processing.

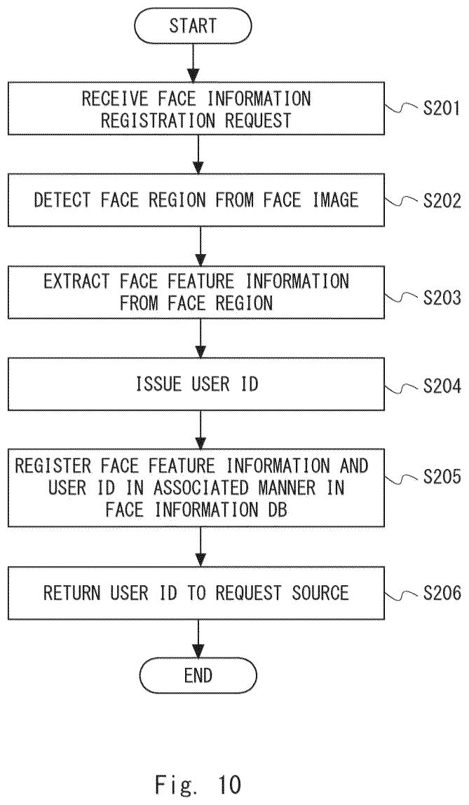

FIG. 10 is a flowchart illustrating a flow of face information registration processing performed by the authentication apparatus according to the second example embodiment. First, the authentication apparatus 200 receives the face information registration request (S201). For example, the authentication apparatus 200 receives the face information registration request from the privilege information issuing apparatus 300 via the network N. Then, the face detection unit 220 detects a face region from the face image included in the face information registration request (S202). Then, the feature point extraction unit 230 extracts feature points (face feature information) from the face region detected in Step S202 (S203). Then, the registration unit 240 issues the user ID 211 (S204). Then, the registration unit 240 registers the extracted face feature information 212 and the issued user ID 211 in an associated manner in the face information DB 210 (S205). Thereafter, the registration unit 240 returns the issued user ID 211 to the request source (for example, the privilege information issuing apparatus 300) (S206). Note that the authentication apparatus 200 may perform the face information registration processing in response to the face information registration request received from any information registration terminal. For example, the information registration terminal is an information processing apparatus, such as a personal computer, a smartphone, or a tablet terminal.

Returning to FIG. 9, the description will be continued.

The privilege information issuing apparatus 300 receives a face information registration result (user ID) from the authentication apparatus 200 via the network N (S113). Then, the privilege information issuing apparatus 300 registers the received user ID 3121 and the terminal information 3122, the attribute information 3123, and the payment information 3124 received in Step S101 in an associated manner in the user information 312 (S114).

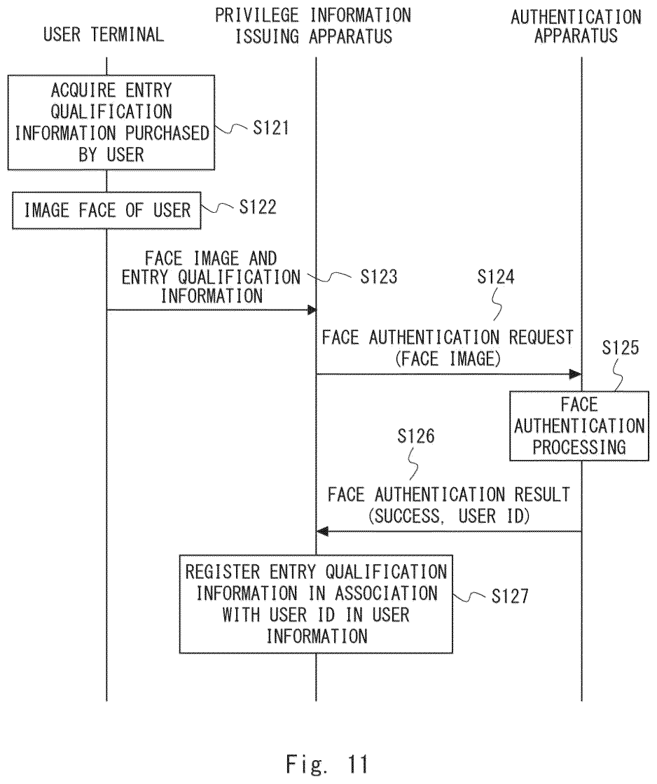

FIG. 11 is a sequence diagram illustrating a flow of entry qualification information registration processing according to the second example embodiment. As a premise, it is assumed that the user U1 has registered the user information in the privilege information issuing apparatus 300 and has purchased entry qualification information of an event held on a predetermined date at the event venue 40. At this time, the user terminal 100 acquires the entry qualification information purchased by the user U1 (S121). For example, the user terminal 100 may receive an input of identification information or the like of the entry qualification information from the user U1. Alternatively, the user terminal 100 may acquire information regarding the entry qualification information provided through a notification from a purchasing site of the entry qualification information. Then, the user terminal 100 images the face of the user U1 (S122). Then, the user terminal 100 transmits a registration request including the face image and the entry qualification information to the privilege information issuing apparatus 300 via the network N (S123).

Then, the privilege information issuing apparatus 300 transmits a face authentication request including the received face image to the authentication apparatus 200 via the network N (S124). In response to the transmission, the authentication apparatus 200 performs face authentication processing (S125).

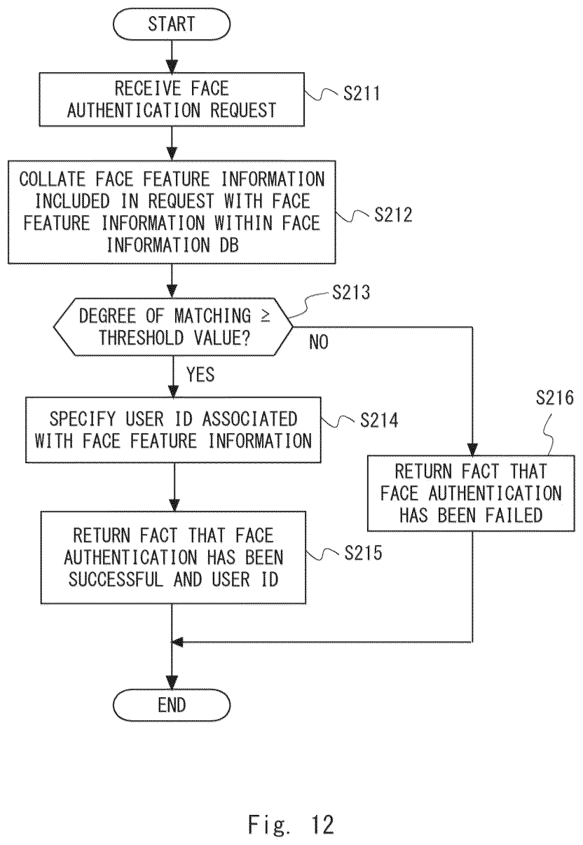

FIG. 12 is a flowchart illustrating a flow of face authentication processing performed by the authentication apparatus according to the second example embodiment. First, the authentication apparatus 200 receives a face authentication request from the privilege information issuing apparatus 300 via the network N (S211). Then, the authentication apparatus 200 extracts face feature information from the face image included in the face authentication request similarly to Steps S202 and S203 described above. Then, the authentication unit 250 of the authentication apparatus 200 collates the face feature information extracted from the face image included in the face authentication request with the face feature information 212 of the face information DB 210 (S212), and calculates a degree of matching. Then, the authentication unit 250 determines whether or not the degree of matching is equal to or greater than a threshold value (S213). In a case where the pieces of face feature information match each other, that is, in a case where the degree of matching between the pieces of face feature information is equal to or greater than the threshold value, the authentication unit 250 specifies the user ID 211 associated with the face feature information 212 (S214). Then, the authentication unit 250 returns a face authentication result, which includes information indicating that the face authentication has been successful and the specified user ID 211, to the privilege information issuing apparatus 300 via the network N (S215). In a case where the degree of matching is less than the threshold value in Step S213, the authentication unit 250 returns the face authentication result including information indicating that the face authentication has been failed to the privilege information issuing apparatus 300 via the network N (S216).

Returning to FIG. 11, the description will be continued.

The privilege information issuing apparatus 300 receives the face authentication result from the authentication apparatus 200 via the network N (S126). Then, the privilege information issuing apparatus 300 determines whether or not the face authentication has been successful. Specifically, the privilege information issuing apparatus 300 refers to the face authentication result and determines that the face authentication has been successful if the face authentication result includes the user ID. Note that in a case where it is determined that the face authentication has been failed, the privilege information issuing apparatus 300 may return the fact that the user has failed the face authentication to the user terminal 100 via the network N.

In a case where the face authentication has been successful, the privilege information issuing apparatus 300 associates the entry qualification information 3125 received in Step S123 with the user ID 3121 included in the face authentication result and registers them in the user information 312 (S127).

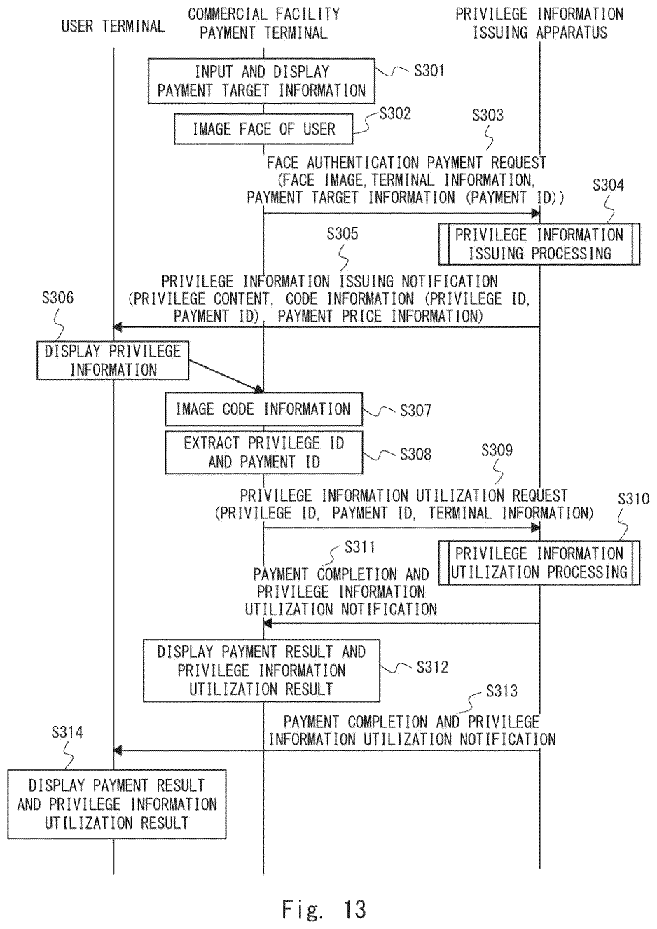

FIG. 13 is a sequence diagram illustrating a flow of privilege information issuing and utilization processing according to the second example embodiment. As a premise, it is assumed that the member information registration processing in FIG. 9 and the entry qualification information registration processing in FIG. 11 described above have been completed for the user U1. In the following description, it is assumed that the user U1 visits the commercial facility 41.

First, the user U1 decides a product to be purchased at the commercial facility 41 and goes to the payment terminal 51 for payment. Then, the payment terminal 51 inputs and displays payment target information through scanning or the like of the product to be purchased and the touch panel 550 (S301). At this time, the payment terminal 51 may issue a payment ID for the input payment target information. Subsequently, the camera 540 of the payment terminal 51 images the face of the user U1 (S302). Then, the payment terminal 51 transmits a face authentication payment request including the face image of the user U1, the terminal information 512, and the payment target information including the payment ID to the privilege information issuing apparatus 300 via the network N (S303). Then, the privilege information issuing apparatus 300 performs privilege information issuing processing (S304).

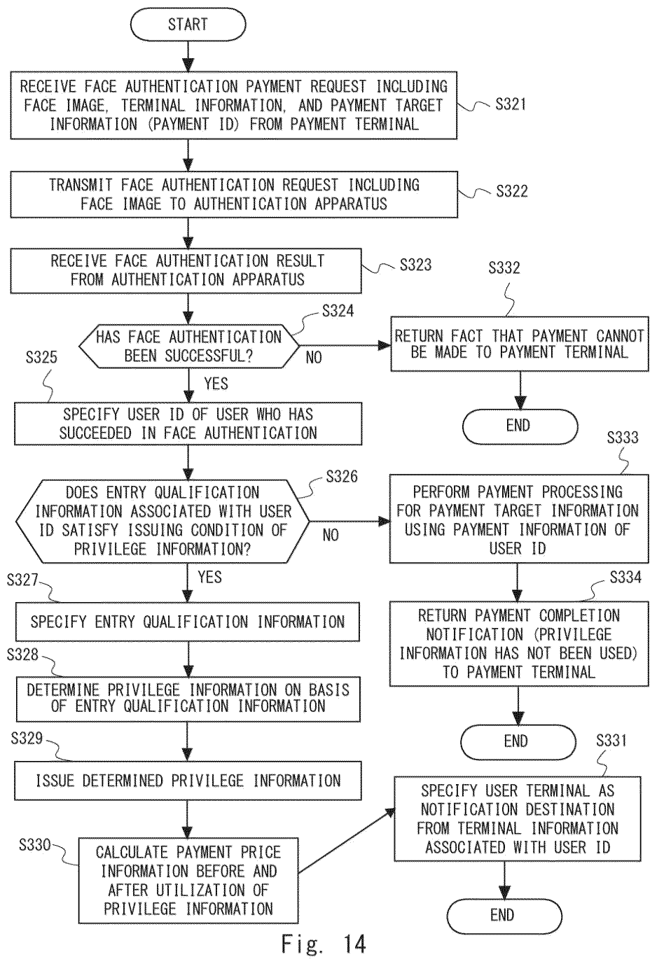

FIG. 14 is a flowchart illustrating a flow of privilege information issuing processing according to the second example embodiment. First, the privilege information issuing apparatus 300 receives the face authentication payment request including the face image, the terminal information, and the payment target information from the payment terminal 51 via the network N (S321). Then, the privilege information issuing apparatus 300 transmits a face authentication request including the face image to the authentication apparatus 200 via the network N (S322). In response to this, the authentication apparatus 200 performs face authentication processing similarly to FIG. 12 described above. Then, the privilege information issuing apparatus 300 receives a face authentication result from the authentication apparatus 200 (S323). Then, the privilege information issuing apparatus 300 determines whether or not the face authentication has been successful (S324).

In a case where the face authentication has been successful, the privilege information issuing apparatus 300 specifies the user ID of the user who has succeeded in the face authentication (S325). Then, the privilege information issuing apparatus 300 determines whether or not the entry qualification information associated with the specified user ID satisfies the privilege information issuing condition (S326)

Specifically, the privilege information issuing apparatus 300 determines whether or not the entry qualification information 3125 is associated with the specified user ID 3121 with reference to the user information 312. In a case where it is determined that the entry qualification information 3125 is associated with the specified user ID 3121, then the privilege information issuing apparatus 300 specifies event information 314 corresponding to the entry qualification information 3125. Then, the privilege information issuing apparatus 300 determines whether or not an event ID of the specified event information is defined by the issuing condition 3134 from the privilege information master 313. In a case where the event ID of the specified event information is defined by the issuing condition, the privilege information issuing apparatus 300 determines that the entry qualification information associated with the user ID of the user who has succeeded in the face authentication satisfies the privilege information issuing condition.

In a case where it is determined that the entry qualification information satisfies the issuing condition in Step S326, the privilege information issuing apparatus 300 reads the entry qualification information 3125 associated with the user ID 3121 of the user who has succeeded in the face authentication from the storage unit 310 and specifies the entry qualification information (S327). For example, the privilege information issuing apparatus 300 may specify a grade of a seat indicated by the seat information and a purchase price included in the read entry qualification information 3125. Then, the privilege information issuing apparatus 300 determines privilege information on the basis of the specified entry qualification information (S328). For example, the privilege information issuing apparatus 300 determines whether the specified grade of the seat is equal to or higher than a grade of a seat defined by the issuing condition, or whether the purchase price of the specified entry qualification information is equal to or higher than a purchase price defined by the issuing condition. In a case where either one of them is satisfied, the privilege information issuing apparatus 300 selects a set of the privilege ID 3131, the target facility 3132, and the privilege content 3133 associated with the issuing condition 3134 and determines the set as a target of issuing from the privilege information master 313. Note that the privilege information issuing apparatus 300 may preferentially select, as the target of issuing, privilege information defining the commercial facility 41 related to payment as the target facility 3132. Also, in a case where the specified grade of the seat is higher than a predetermined grade, or in a case where the purchase price of the specified entry qualification information is equal to or greater than a predetermined price, for example, the privilege information issuing apparatus 300 may select and determine privilege information of privilege content of a discount rate or a discount price higher than usual. Also, the privilege information issuing apparatus 300 may determine a validity period of the privilege information on the basis of the specified entry qualification information. In a case where the privilege content defines that the discount can be immediately applied to this payment, for example, the privilege information issuing apparatus 300 may determine “within 30 minutes from a current clock time” as the validity period. Alternatively, in a case where the target facility is other than the commercial facility 41, the privilege information issuing apparatus 300 may determine “within the date of issuing” or “within a predetermined period from the date of issuing” as the validity period.

Then, the privilege information issuing apparatus 300 issues the privilege information determined in Step S328 (S329). Specifically, the privilege information issuing apparatus 300 associates the privilege ID of the determined privilege information, the target facility, and the privilege content as the issued privilege ID 3151, the target facility 3155, and the privilege content 3156 and generates the privilege management information 315. In addition, the privilege information issuing apparatus 300 sets the user ID specified in Step S325 as the user ID 3152, the current date and time as the issuing date and time 3153, and the determined validity period as the validity period 3154 in the generated privilege management information 315. The privilege information issuing apparatus 300 registers the generated and set privilege management information 315 in the storage unit 310. Additionally, the privilege information issuing apparatus 300 specifies the payment ID included in the face authentication payment request and generates code information including the specified payment ID and the privilege ID of the issued privilege information.

Then, the privilege information issuing apparatus 300 calculates payment price information before and after utilization of the issued privilege information (S330). Specifically, the privilege information issuing apparatus 300 calculates, as the payment price information before utilization of the privilege information, a product price, a tax price, a payment price that is a total of the product price and the tax price of the payment target information included in the face authentication payment request. Furthermore, in a case where the privilege information is a discount rate, for example, the privilege information issuing apparatus 300 calculates, as the payment price information after utilization of the privilege information, a discount price obtained by applying the discount rate to the product price, the price after the discount, the tax price, and a payment price that is a total of the price after the discount and the tax price.

Thereafter, the privilege information issuing apparatus 300 specifies the user terminal 100 as a notification destination from the terminal information 3122 associated with the user ID 3121 specified in Step S325 (S331).

Note that in a case where the face authentication is failed in Step S324, the privilege information issuing apparatus 300 returns the fact that payment cannot be made to the payment terminal 51 (S332). Furthermore, in a case where it is determined in Step S326 that the entry qualification information does not satisfy the issuing condition, the privilege information issuing apparatus 300 performs the payment processing without using the privilege information. In other words, the privilege information issuing apparatus 300 performs the payment processing for the payment target information using the payment information 3124 of the specified user ID 3121 (S333). For example, the privilege information issuing apparatus 300 specifies the payment information 3124 associated with the specified user ID 3121 from the user information 312. Then, the privilege information issuing apparatus 300 transmits, to a payment server (not illustrated), an instruction for withdrawing the price (payment price) of the payment target information included in the face authentication payment request using the specified payment information 3124 and receives a payment result. Thereafter, the privilege information issuing apparatus 300 returns a payment completion notification including the fact that the privilege information has not been used to the payment terminal 51 (S334). After Step S332 or S334, the privilege information issuing and utilization processing (face authentication payment processing) is ended.

Returning to FIG. 13, the description will be continued. The privilege information issuing apparatus 300 transmits a privilege information issuing notification to the user terminal 100, which is the notification destination specified in Step S331, via the network N (S305). Here, the privilege information issuing apparatus 300 includes the privilege content and the code information of the privilege information issued in Step S329 and the payment price information before and after the utilization of the privilege information calculated in Step S330 in the privilege information issuing notification. In response to the notification, the user terminal 100 displays the privilege information, the payment price before and after utilization of the privilege information, and the like provided through the notification (S306).

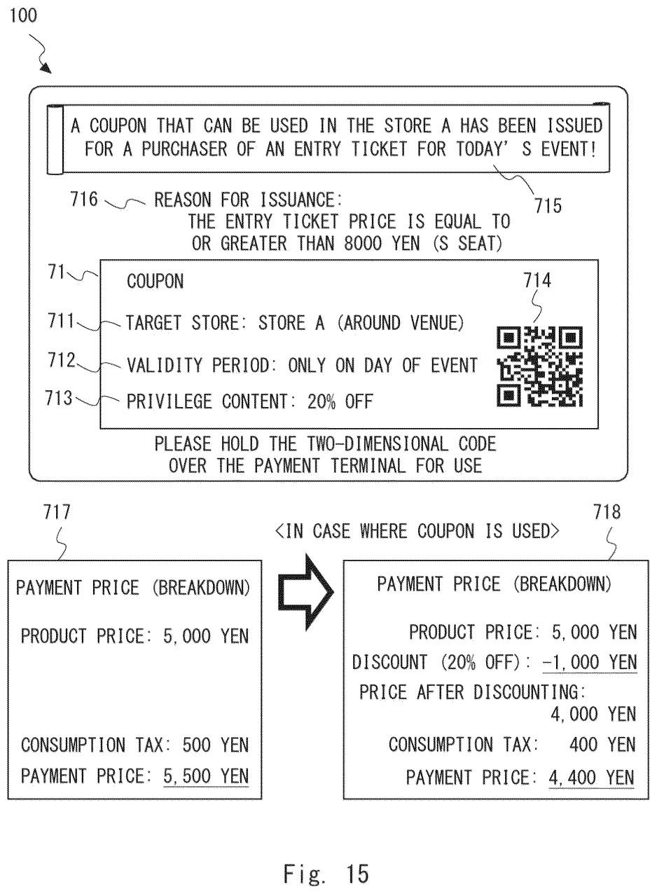

FIG. 15 is a diagram illustrating a display example of the issued privilege information according to the second example embodiment. A notification message 715 is text information included in the privilege information provided through the notification. The reason for issuance 716 is text information included in the privilege information provided through the notification and indicating a reason that the privilege information has been issued. Here, the notification message 715 indicates “A coupon that can be used in the store A has been issued for a purchaser of an entry ticket for today's event!” Also, the reason for issuance 716 indicates that the entry ticket price is equal to or greater than 8000 yen (S seat). A coupon 71 displays a target store 711, a validity period 712, privilege content 713, and code information 714. The target store 711 is the store A (for example, the commercial facility 41) around the event venue 40, and the validity period 712 indicates that the coupon is valid only on the event day. The privilege content 713 indicates that the product price is “20% off”. The code information 714 is a two-dimensional code including the privilege ID and the payment ID. Note that the target store 711, the validity period 712, the privilege content 713, the code information 714, the notification message 715, and the reason for issuance 716 are examples and are not limited thereto.

In addition, payment price information 717 before utilization of the coupon indicates a product price, a consumption tax, and a payment price, and payment price information 718 after utilization of the coupon indicates a discount price from the product price, a price after the discount, a consumption tax thereof, and a payment amount. However, the price and the discount rate are merely examples and are not limited thereto.

Returning to FIG. 13, the description will be continued. It is assumed that the user U1 has checked, through the user terminal 100, the coupon 71, the payment price information 717 before utilization of the coupon, and the payment price information 718 after utilization of the coupon in FIG. 15 described above and has decided to use the coupon 71 in this payment. Thus, code information of the first coupon 71 displayed on the user terminal 100 is held over the camera 540 of the payment terminal 51. In response to this, the payment terminal 51 images the code information of the first coupon 71 with the camera 540 (S307). Then, the payment terminal 51 analyzes the captured image and extracts the privilege ID and the payment ID included in the code information (S308). Then, the payment terminal 51 transmits a privilege information utilization request including the privilege ID, the payment ID, and the terminal information 512 to the privilege information issuing apparatus 300 via the network N (S309). Then, the privilege information issuing apparatus 300 performs privilege information utilization processing (S310).

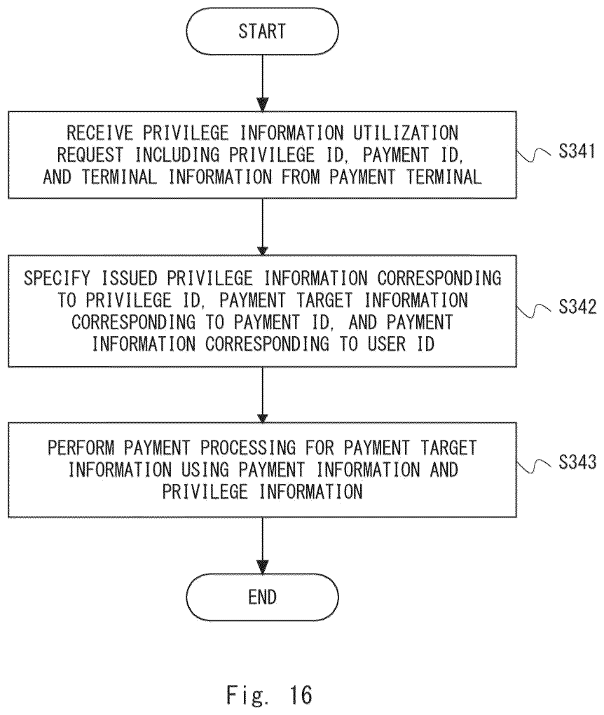

FIG. 16 is a flowchart illustrating a flow of the privilege information utilization processing according to the second example embodiment. The privilege information issuing apparatus 300 receives a privilege information utilization request including the privilege ID, the payment ID, and the terminal information from the payment terminal 51 (S341). Then, the privilege information issuing apparatus 300 specifies privilege information that has already been issued, payment target information, and payment information (S342). In other words, the privilege information issuing apparatus 300 specifies the privilege information that has already been issued and corresponding to the privilege ID included in the received privilege information utilization request. Specifically, the privilege information issuing apparatus 300 specifies privilege content 3156 associated with the set of the issued privilege ID 3151 and the user ID 3152 specified in Step S325 from the privilege management information 315. Furthermore, the privilege information issuing apparatus 300 specifies the payment target information corresponding to the payment ID included in the received privilege information utilization request. Specifically, the privilege information issuing apparatus 300 specifies the payment price in the payment price information after utilization of the privilege information calculated in Step S330. Also, the privilege information issuing apparatus 300 specifies the payment information corresponding to the user ID specified in Step S325. Specifically, the privilege information issuing apparatus 300 specifies the payment information 3124 associated with the specified user ID 3121 from the user information 312.

Thereafter, the privilege information issuing apparatus 300 performs payment processing for the specified payment target information using the specified payment information and privilege information (S343). Then, the privilege information issuing apparatus 300 transmits an instruction for withdrawing the specified payment price to the payment server (not illustrated) using the specified payment information 3124 and receives a payment result.

Returning to FIG. 13, the description will be continued. After Step S343, the privilege information issuing apparatus 300 transmits a payment completion and privilege information utilization notification to the payment terminal 51 via the network N (S311). In response to the transmission, the payment terminal 51 receives the payment completion and privilege information utilization notification and displays a payment result and a privilege information utilization result (S312). Also, the privilege information issuing apparatus 300 transmits the payment completion and privilege information utilization notification to the user terminal 100 of the user U1 via the network N (S313). In response to the transmission, the user terminal 100 receives the payment completion and privilege information utilization notification and displays a payment result and a privilege information utilization result (S314).

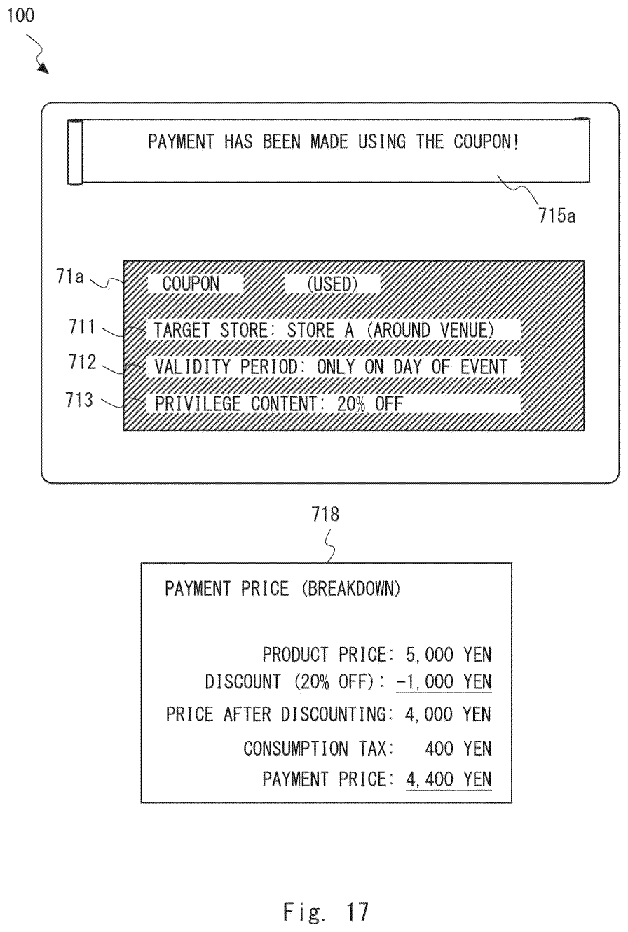

FIG. 17 is a diagram illustrating a display example of a result of payment using the privilege information according to the second example embodiment. The payment price information 718 after utilization of a coupon indicates “The payment has been made using the coupon!” A coupon 71a indicates that the coupon 71 has already been used. Then, the payment price information 717 before utilization of the coupon is hidden, and the payment price information 718 after utilization of the coupon is left and displayed. Note that the display example after utilization of the privilege information is not limited thereto.

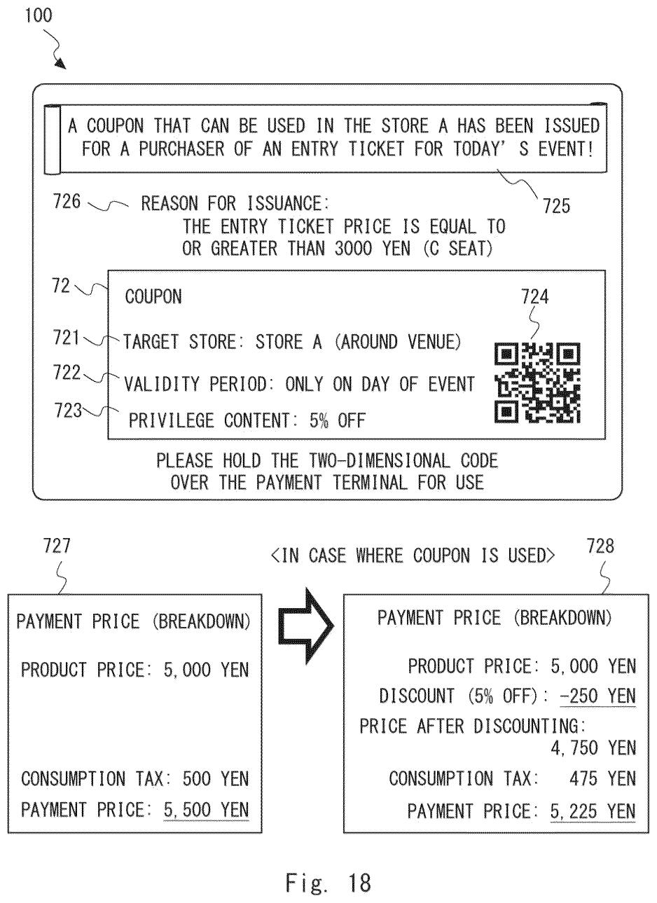

FIG. 18 is a diagram illustrating a display example of other issued privilege information according to the second example embodiment. A notification message 725 is similar to the notification message 715 described above. A reason for issuance 726 indicates that the entry ticket price is equal to or greater than 3000 yen (C seat). A coupon 72 displays a target store 721, a validity period 722, privilege content 723, and code information 724. The target store 721 and the validity period 722 are similar to the target store 711 and the validity period 712 described above. The privilege content 723 indicates that the product price is “5% off”. In other words, the reason for issuance 726 indicates that the discount rate is low because the entry ticket price is less expensive as compared with the reason for issuance 716 of the coupon 71 described above. The code information 724 is a two-dimensional code including the privilege ID and the payment ID. Note that the target store 721, the validity period 722, the privilege content 723, the code information 724, the notification message 725, and the reason for issuance 726 are examples and are not limited thereto.

In addition, the payment price information 727 before utilization of the coupon is similar to the payment price information 717 described above. On the other hand, since the payment price information 728 after utilization of the coupon is the discount rate of 5%, the discount price is 250 yen, and the payment price is 5225 yen. Therefore, the payment price information 728 after utilization of the coupon indicates that the price to be paid is higher than the payment price information 718 after the utilization of the coupon described above. However, the price and the discount rate are merely examples and are not limited thereto.

Note that in a case where the user U1 decides not to use the coupon 71 after Step S306 in FIG. 13 described above, the user U1 may close the screen of the user terminal 100 and notify the store staff that the user U1 will not use the coupon 71. In this case, the payment terminal 51 transmits a payment request including the fact that the user U1 will not use the coupon 71 and the payment ID to the privilege information issuing apparatus 300. Then, the privilege information issuing apparatus 300 executes Steps S333 and S334 in FIG. 14 described above.

Alternatively, buttons for selecting availability of the coupon may be provided on the screen in FIG. 15. Then, in a case where any selection button is pressed by the user U1, the user terminal 100 may transmit the result of selecting the availability to the payment terminal 51 through near-field wireless communication or the like. Step S307 and subsequent steps described above are executed in a case where the selection result indicates that the coupon is available, or the payment terminal 51 transmits the payment request including the fact that the user U1 will not use the coupon 71 and the payment request including the payment ID to the privilege information issuing apparatus 300 as described above in a case where the selection result indicates that the coupon is not available.

As described above, privilege information that can be used immediately at the time of payment at a commercial facility in the surrounding is granted to the user as an incentive of having the entry qualification information of the event held at the event venue 40. This can promote a consumption action at the commercial facility and also can be a motivation of purchase of the entry qualification information next time. Therefore, it is possible to revitalize a region including the event venue and the commercial facilities around the event venue by sending customers therebetween.

Note that although the privilege information is determined on the basis of the seat information and the ticket purchase price, in particular, as the entry qualification information in Step S328 in FIG. 13 described above, a way of determining the privilege information is not limited thereto. For example, the privilege information issuing apparatus 300 may determine the privilege information on the basis of a purchase history of a user who has succeeded in the face authentication purchasing the entry qualification information for the past events. In a case where the number of times of purchase of the entry qualification information of the past events held at the event venue 40 is equal to or greater than a predetermined number of times, or in a case where the total purchase price is equal to or greater than a predetermined price, for example, a privilege that is better than usual may be granted. The privilege that is better than usual is, for example, a higher discount rate, a higher discount price, or a higher price of a free present. Alternatively, in a case where the entry qualification information is purchased for the first time, an initial privilege may be granted.

Alternatively, the privilege information issuing apparatus 300 may determine the privilege content in consideration of attribute information of the user who has succeeded in the face authentication. For example, a free present suitable for a user's preference or a discount amount, a discount price, points addition, or the like in accordance with a member grade may be set as the privilege content. It is thus possible to issue the suitable privilege content and privilege information at the target facility in accordance with the user's preference or the like.

### Third Example Embodiment

A third example embodiment is a modified example of the second example embodiment described above. In the third example embodiment, privilege information that can be used in a commercial facility 41 or the like in the neighborhood of an event venue 40 is issued at the time of user's registration of entry qualification information and the user uses the privilege information later will be described. For example, an issuing unit 344 issues privilege information for a user U1 who has succeeded in face authentication in response to a privilege issuing request received from a user terminal 100 and has registered entry qualification information. Note that an overall configuration and an individual configuration of the privilege information issuing system 1000 according to the third example embodiment are similar to those of the second example embodiment described above, and repeated description and illustration will thus be omitted.

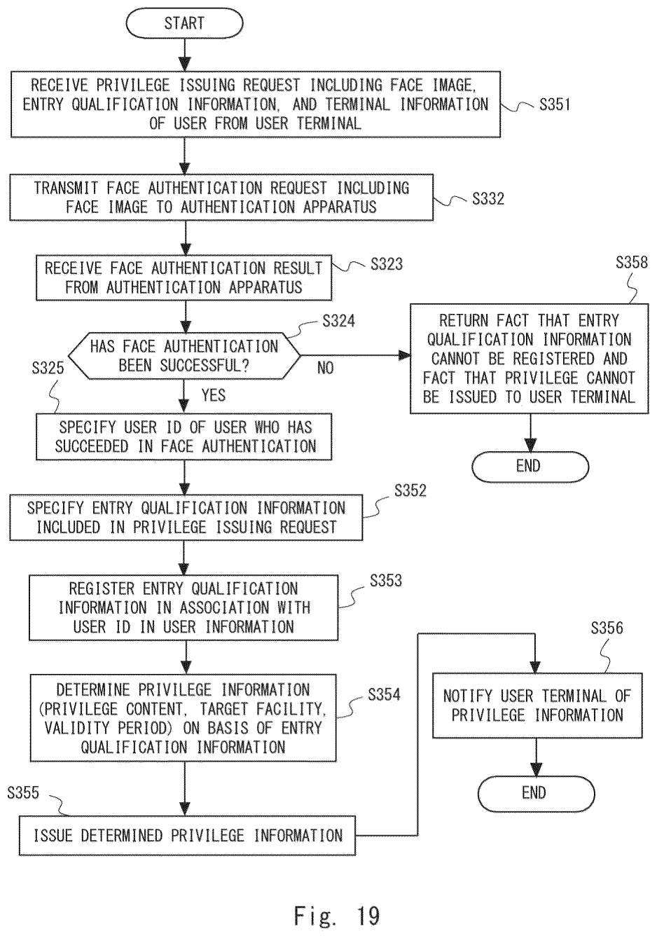

FIG. 19 is a flowchart illustrating a flow of privilege information issuing processing according to the third example embodiment. Here, it is assumed that although the member information registration processing in FIG. 9 described above has been completed, and the user U1 has purchased entry qualification information, registration in a privilege information issuing apparatus 300 has not yet been performed.

Therefore, a user terminal 100 acquires the entry qualification information purchased by the user U1 and images the face of the user U1 in response to instruction in a privilege issuing request from the user U1. Then, the user terminal 100 transmits the privilege issuing request including the face image, the entry qualification information, and terminal information 112 to the privilege information issuing apparatus 300 via a network N.

In response to the transmission, the privilege information issuing apparatus 300 receives the privilege issuing request including the face image, the entry qualification information, and the terminal information of the user U1 from the user terminal 100 via the network N (S351). Then, Steps S332 to S325 in FIG. 13 described above are executed. In other words, in a case where the user U1 has succeeded in face authentication, and a user ID is specified, the privilege information issuing apparatus 300 specifies the entry qualification information included in the received privilege issuing request (S352). Then, the privilege information issuing apparatus 300 registers entry qualification information 3125 in association with the specified user ID 3121 in user information 312 (S353). Then, the privilege information issuing apparatus 300 determines privilege information (privilege content, a target facility, a validity period) on the basis of the specified entry qualification information (S354). Specifically, the processing may be executed similarly to Step S328 in FIG. 13 described above. Note that since the privilege information is not used at the time of payment in the present example embodiment, there is no limitation of commercial facilities regarding the payment, and the validity period may also be arbitrarily determined. Then, the privilege information issuing apparatus 300 issues the privilege information determined in Step S354 described above (S355). Thereafter, the privilege information issuing apparatus 300 notifies the user terminal 100 of the privilege information (S356). Specifically, the privilege information issuing apparatus 300 transmits a privilege information issuing notification to the user terminal 100 which is a transmission source of the privilege issuing request, via the network N.

Note that in a case where the face authentication is failed in Step S324, the privilege information issuing apparatus 300 returns the fact that the entry qualification information cannot be registered and the fact that the privilege cannot be issued to the user terminal 100 (S358).

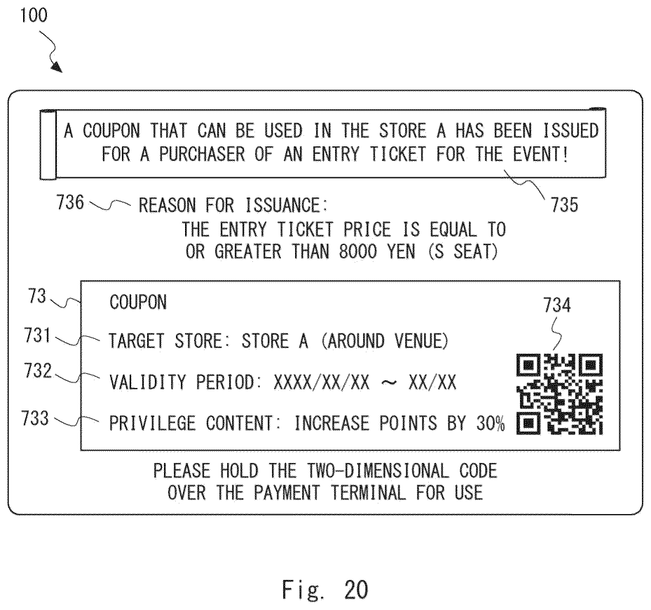

FIG. 20 is a diagram illustrating a display example of issued privilege information according to the third example embodiment. A notification message 735 is text information included in the privilege information provided through the notification. The reason for issuance 736 is similar to the reason for issuance 716 described above. Here, the notification message 735 indicates “A coupon that can be used in the store A has been issued for a purchaser of an entry ticket for the event!” A coupon 73 displays a target store 731, a validity period 732, privilege content 733, and code information 734. The target store 731 is similar to the target store 711 described above. The validity period 732 indicates a certain period. The privilege content 733 indicates that points to be added in accordance with a purchase price is increased by 30%. The code information 734 is a two-dimensional code including a privilege ID. Note that the target store 731, the validity period 732, the privilege content 733, the code information 734, the notification message 735, and the reason for issuance 736 are examples and are not limited thereto.

This enables the user U1 to recognize that the user can use the coupon 73 in the store A within the validity period 732 as an incentive of purchasing and registering the entry qualification information and is motivated to visit the store A, for example. Then, the user U1 can select and display the coupon 71 using the user terminal 100 and use the coupon 73 in the store A. At this time, the payment terminal 51 images code information of the code information 734 with the camera 540, analyzes the captured image, extracts the image as a privilege ID, and images the face of the user U1. Then, the payment terminal 51 transmits a face authentication payment request including the face image, the payment target information, the privilege ID, and the terminal information 512 to the privilege information issuing apparatus 300 via the network N. Then, the authentication control unit 342 and the payment control unit 347 of the privilege information issuing apparatus 300 performs the payment processing using the face authentication of the user U1 and the privilege information as described above. In this manner, the commercial facility 41 can get profit through the purchase of the entry qualification information of the event. It is thus possible to encourage the purchaser of the entry qualification information for the event to use the commercial facilities around the event venue according to the present example embodiment as well.

### Fourth Example Embodiment

A fourth example embodiment is a modified example of the second or third example embodiment described above. The fourth example embodiment is a specific example of a case where privilege information is issued on the basis of attribute information of a user. A registration unit according to the fourth example embodiment further registers the attribute information of the user in association with identity authentication information in a storage apparatus. Then, a specification unit further specifies the attribute information associated with the identity authentication information with which identity authentication has been successful, and an issuing unit issues privilege information on the basis of the specified attribute information as well. In particular, it is assumed that an event in the fourth example embodiment is a sport game, the specification unit further specifies a support target of the user on the basis of the specified attribute information, and the issuing unit issues the privilege information on the basis of the specified support target as well. Furthermore, it is only necessary for the issuing unit to issue the privilege information in consideration of a relationship between the specified support target and a result of the sport game. Alternatively, the attribute information may include seat information for watching the sport game, and it is only necessary for the specification unit to specify the support target of the user from the seat information. Alternatively, the attribute information may include a method of purchasing entry qualification information for the sport game, and it is only necessary for the specification unit to specify the support target of the user from the purchasing method.

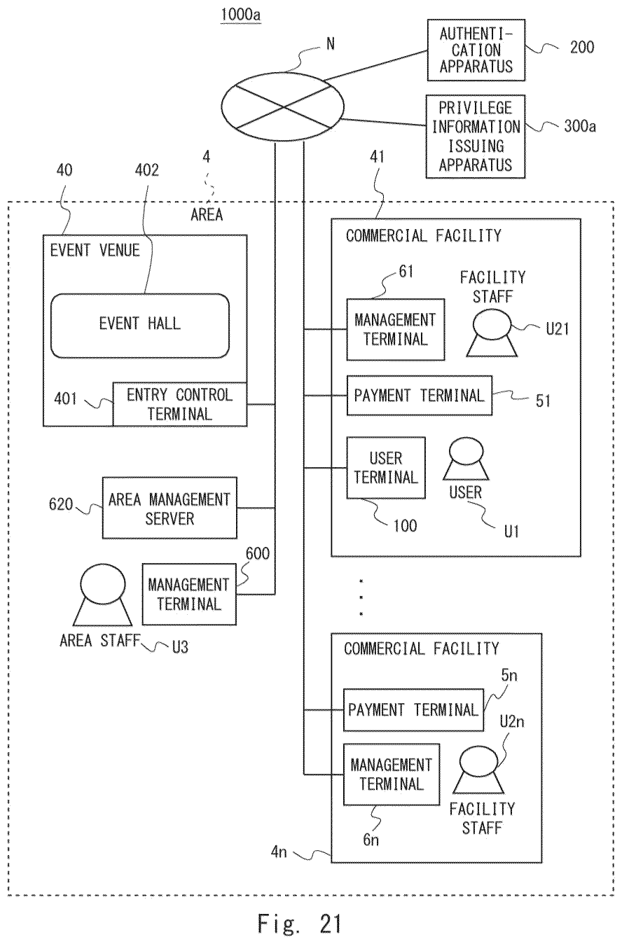

FIG. 21 is a block diagram illustrating an overall configuration of a privilege information issuing system 1000a according to the fourth example embodiment. Compared to FIG. 3 described above, an area management server 620 is added to an area 4, and a privilege information issuing apparatus 300a is changed in the privilege information issuing system 1000a. Note that since the other configurations of the privilege information issuing system 1000a according to the fourth example embodiment are similar to those of the second or third example embodiment described above, and repeated description and illustration will be omitted.

An area management server 620 is a computer server that manages information regarding an event venue 40, a commercial facility 41, and the like included in the area 4, cooperative business operators, and the like. For example, the area management server 620 collects a situation and a sport game result of the sport game that is an event held in the event venue 40 in real time and returns the sport game situation and the sport game result in response to an acquisition request via the network N.

In a case where a sport game end notification is received from the area management server 620, the privilege information issuing apparatus 300a determines that the sport game has ended. Alternatively, in a case where the privilege information issuing apparatus 300a transmits an acquisition request of the sport game situation or the sport game result designating an event ID (sport game ID) to the area management server 620 and receives the sport game result along with the sport game end notification from the area management server 620, the privilege information issuing apparatus 300a determines that the sport game result has been acquired.

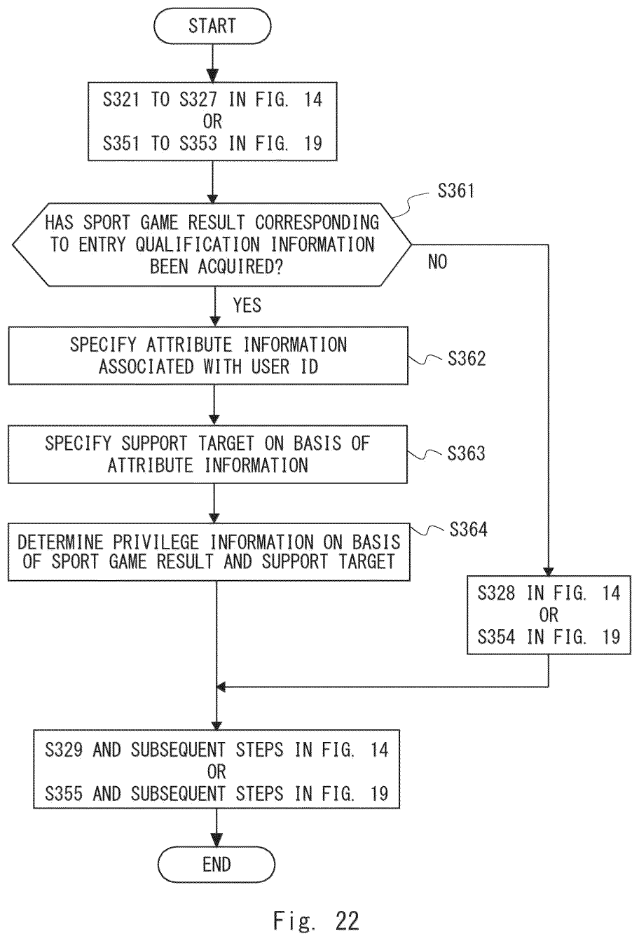

FIG. 22 is a flowchart illustrating a flow of privilege information issuing processing according to the fourth example embodiment. First, the privilege information issuing apparatus 300a executes Steps S321 to S327 in FIG. 14 described above or Steps S351 to S353 in FIG. 19. Then, the privilege information issuing apparatus 300a determines whether or not the sport game result corresponding to the entry qualification information has been acquired (S361). In a case where the privilege information issuing apparatus 300a receives the sport game end notification (sport game result) from the area management server 620 as described above, for example, the privilege information issuing apparatus 300a determines that the sport game result has been acquired.

Then, the privilege information issuing apparatus 300a specifies attribute information 3123 associated with the specified user ID 3121 (S362). Specifically, the privilege information issuing apparatus 300a specifies the attribute information 3123 associated with the user ID 3121 specified in Step S325 from the user information 312.

Then, the privilege information issuing apparatus 300a specifies a support target on the basis of the specified attribute information 3123 (S363). In a case where the attribute information 3123 includes a support target of a sport player or a team, for example, the privilege information issuing apparatus 300a specifies the support target from the attribute information 3123. Alternatively, the privilege information issuing apparatus 300a may specify the support target by estimating the support target from information indicating a hobby, a preference, or an interest in the attribute information 3123. Alternatively, in a case where the entry qualification information associated with the attribute information includes seat information for watching the sport game, the privilege information issuing apparatus 300a may specify the support target of the user from the seat information. In a case where the seat of a baseball stadium is on the third base side or the left stand, for example, the first-batting team may be specified as the support target. Also, in a case where the user is estimated to be a fan of a specific player from the attribute information, the team to which the player belongs may be regarded as the support target. Alternatively, in a case of an individual sport, the player specified from the attribute information may be regarded as the support target.

Alternatively, in a case where a method of purchasing the entry qualification information for the sport game is included in association with the attribute information, the privilege information issuing apparatus 300a may specify the support target of the user from the purchasing method. The “method of purchasing the entry qualification information for the sport game” is, for example, a dedicated application or a dedicated website for fans provided by a specific team, and it is assumed that the user U1 has purchased the ticket for the sport game via the dedicated application installed in the user terminal 100 or the dedicated website. Then, the attribute information or the entry qualification information may include records of the dedicated application used for the purchasing or the dedicated site through which the purchase has been made. In these cases, the privilege information issuing apparatus 300a may specify the dedicated application or the like from the attribute information or the entry qualification information or the purchase history information associated with the attribute information, and specify the team corresponding to the dedicated application or the like as the support target. Alternatively, the user terminal may display an input field for a support target team or player on the registration screen for the user information (member information) or the entry qualification information, include the support target input by the user in the attribute information, and transmit a registration request to the privilege information issuing apparatus 300.

Thereafter, the privilege information issuing apparatus 300a determines privilege information on the basis of the sport game result acquired in Step S361 and the support target specified in Step S363 (S364). For example, the privilege information issuing apparatus 300a may determine the privilege information in a case where the specified support target is a team that has won in the sport game, and may not determine (issue) the privilege information in a case where the specified support target is a team that has lost in the sport game.

Furthermore, the privilege information issuing apparatus 300a may select the privilege content and the target facility from the privilege information master 313 on the basis of the attribute information, and may further change the privilege content and the target facility in accordance with the sport game result. For example, different target facilities may be assigned for the wining team and the losing team. Furthermore, in a case where the sport game result shows a large margin, privilege content that is more advantageous (a higher discount rate or the like) than usual may be granted to the user, the support target of which is the winning team.

Note that the privilege information issuing apparatus 300a may determine the validity period of the privilege information differently in accordance with the sport game result. For example, the privilege information issuing apparatus 300a may set the validity period of the privilege information to 4 hours if the support target is the wining team and may set the validity period of the privilege information to 1 hour if the support target is the losing team.

Note that in a case where it is determined in Step S361 that the sport game result has not been acquired, the privilege information issuing apparatus 300a executes Step S328 in FIG. 14 described above or Step S354 in FIG. 19 and determines the privilege information.

In a case where Step S364 or S328 is executed after Steps S321 to S327 in FIG. 14 described above, the privilege information issuing apparatus 300a executes Step S329 and subsequent steps in FIG. 14 described above. In a case where Step S364 or S354 is executed after Steps S351 to S353 in FIG. 19 described above, the privilege information issuing apparatus 300a executes Step S355 and subsequent steps in FIG. 19 described above. In this manner, the determined privilege information is issued and provided through a notification.

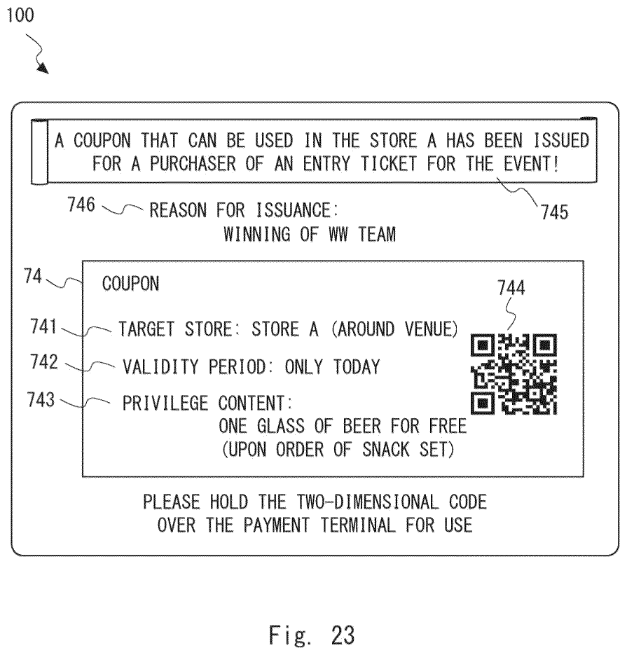

FIG. 23 is a diagram illustrating a display example of issued privilege information according to the fourth example embodiment. As a premise, it is assumed that the support target of the user U1 is a WW team. A notification message 745 is similar to the notification message 735 described above. The reason for issuance 746 indicates “winning of the WW team”. A coupon 74 displays a target store 741, a validity period 742, privilege content 743, and code information 744. The target store 741 is similar to the target store 711 described above. The validity period 742 indicates “only today”. The privilege content 743 indicates that a glass of beer (upon an order of a snack set) will be free. The code information 744 is a two-dimensional code including a privilege ID (and a payment ID). Note that the target store 741, the validity period 742, the privilege content 743, the code information 744, the notification message 745, and the reason for issuance 746 are examples and are not limited thereto.

In this manner, the privilege information in consideration of the attribute of the user U1, especially, the support target in the sport game is issued, and an advantage of purchasing the entry qualification information and a motivation to use the commercial facility 41 or the like in the neighborhood where the privilege information can be used are obtained. It is thus possible to encourage the purchaser of the entry qualification information for the event to use the commercial facilities around the event venue according to the present example embodiment as well.

### Other Example Embodiments

Note that the privilege information may not necessarily be issued at the time of the face authentication payment as in the second example embodiment or at the time of the registration of the entry qualification information as in the third example embodiment described above and may be issued at an arbitrary timing from the registration of the entry qualification information to the face authentication payment. For example, the user terminal may transmit a privilege issuing request including the face image of the user to the privilege information issuing apparatus 300 in response to a user's operation after the processing of registering the entry qualification information. In this case, the privilege information issuing apparatus 300 performs Steps S332 to S329 in FIG. 14 described above after receiving the privilege issuing request and notifies the user terminal 100 of the privilege information. Then, the user terminal 100 displays the code information 734 of the issued privilege information (coupon) as illustrated in FIG. 20 described above. Thereafter, the user holds the code information 734 displayed on the user terminal 100 over the payment terminal and can use the privilege information through face authentication payment as described above in the third example embodiment.

Alternatively, the payment at the time of the utilization of the privilege information may not be the face authentication payment. For example, the payment terminal may read the code information displayed in S306 (S307, S308) after Step S301 in FIG. 13 described above and transmit the privilege information utilization request to the privilege information issuing apparatus 300 (S309).

Alternatively, privilege information issuing apparatus 300 may issue the privilege information (S321 to S329 in FIG. 14) in a case where face authentication has been successful at the time of the face authentication payment as in the second example embodiment described above and perform the payment processing (S343 in FIG. 16) using the issued privilege information as it is. Alternatively, in a case where there is privilege information that has already been issued and can be used for the user who has succeeded in the face authentication at the time of the face authentication payment, the privilege information issuing apparatus 300 may perform the payment processing using the privilege information. Therefore, the user may be able to use the privilege information without causing the code to be read as long as the user performs the face authentication.

Furthermore, the privilege information issuing apparatus may issue and provide a notification of the privilege information for the user who has entry qualification information of a specific event or who has already entered the event venue periodically or at a predetermined timing. In other words, the privilege information issuing apparatus may automatically recommend the privilege information to the corresponding user without depending on the privilege issuing request from the user.

Note that the validity period (available period) of the privilege information may be several hours including at least either a time zone before a start of the event or a time zone after the start or only the day on which the event is held.

Note that the privilege information issuing apparatus may issue the privilege information that can be used in the commercial facilities around the event venue if the user who has purchased the entry qualification information and has entered the event venue through the identity authentication makes payment at a store inside the event venue 40. Also, the privilege information issuing apparatus may issue the privilege information that can be used in the stores inside the event venue 40 if the user who has purchased the entry qualification information makes payment at a commercial facility in the surroundings through identity authentication.

Note that the issuing unit 344 may issue the privilege information in accordance with the attribute information associated with the user U1. For example, the issuing unit 344 issues the privilege information in which the validity period, the privilege content, and the target facility determined on the basis of the attribute information have been set. In addition, the issuing unit 344 issues the privilege information that grants the privilege content in accordance with the attribute information. In addition, the issuing unit 344 may issue the privilege information that can be used in different facilities in accordance with the attribute information from among the facilities in the neighborhood. For example, the issuing unit 344 may issue a coupon for a facility “cafe” if the attribute information indicates a female, and may issue a coupon of for a facility “ramen shop” if the attribute information indicates a male.

Note that the issuing unit 344 described above may select a commercial facility as a target of issuing of the privilege information from among a plurality of commercial facilities in the neighborhood of the event venue on the basis of the entry qualification information, the attribute information, and the payment content. Then, it is only necessary for the issuing unit 344 to issue the privilege information that can be used in the selected commercial facility for the user U1 who has succeeded in the face authentication.

Note that the aforementioned example embodiments have been described on the assumption that the identity authentication is based on the face authentication, the present disclosure is not limited thereto. In addition, although the description has been made on the assumption that the payment processing is based on the face authentication payment, the present disclosure may be applied to another payment method. In addition, the identity authentication at the time of issuing of the privilege information, the identity authentication at the time of entry or exiting of the event venue, and the identity authentication at the time of utilization of the privilege information in the commercial facility in the neighborhood of the event venue are also not limited to face authentication, and other identity authentication, which will be described later, may be applied.

In addition, although the aforementioned embodiments have been described on the assumption that the identity authentication (authentication for checking the identity, identity specification processing, and the like) is based on the face authentication, other biometric authentication using biometric information may also be performed. As the biometric authentication and the biometric information, other technologies using a captured image of a person can be applied. For example, as the biometric information, data (feature amount) calculated from physical characteristics unique to an individual such as a fingerprint, a voiceprint, a vein, a retina, an iris of a pupil, and a pattern (pattern) of a palm may be used. For the biometric authentication, feature information indicating the physical characteristics of a person may be extracted from the captured image of a part of the body of the user, the extracted feature information may be collated with feature information registered in advance, and the authentication may be regarded as being successful if the degree of matching is equal to or greater than the threshold value. For example, the biometric authentication may be authentication based on the appearance shape of the person. In this case, the feature information is information regarding the appearance shape of the person, for example, information indicating features such as a body shape, a height, and clothes. In addition, instead of the biometric authentication, another identity authentication may be applied, and the biometric information may also be another identity authentication information. Examples of the identity authentication information include, but are not limited to, a combination of a user ID, an ID, and a password, description contents (an identification number and the like or a password) of an identification card such as an individual number and a driver's license, an electronic certificate, code information, and the like. The code information may be a two-dimensional code, for example, a QR code (registered trademark).

Note that although the second example embodiment and the like are described on the assumption that the authentication apparatus 200 and the privilege information issuing apparatus 300 are different information processing apparatuses, the authentication apparatus 200 and the privilege information issuing apparatus 300 may be the same information processing apparatus. For example, the privilege information issuing apparatus 300 may further register the face feature information in association with the user ID 3121 of the user information 312. In this case, the control unit 340 only needs to further have the functions of the face detection unit 220, the feature point extraction unit 230, the registration unit 240, and the authentication unit 250 in FIG. 4.

Note that in the entry qualification information registration processing in FIG. 11 described above, the entry qualification information may not necessarily be registered using the success in face authentication as a condition. Alternatively, in a case where the user ID issued at the time of registration of the user information is stored in the user terminal, the user terminal may transmit a registration request including the user ID and the entry qualification information instead of the face image to the privilege information issuing apparatus 300 in Step S123. In that case, the privilege information issuing apparatus 300 may register the user ID and the entry qualification information included in the received registration request in an associated manner in user information. Alternatively, a sales server of the entry qualification information may transmit a registration request including the user ID and the entry qualification information of the purchaser to the privilege information issuing apparatus 300 at the time of purchasing the entry qualification information, and cause the privilege information issuing apparatus 300 to register the user ID and the entry qualification information.

Note that the entry qualification information registration processing in FIG. 11 described above may be performed by an information registration terminal instead of the user terminal 100. The information registration terminal may be, for example, a KIOSK terminal installed in a station or a commercial facility. In this case, the user terminal 100 transfers the entry qualification information to the KIOSK terminal, for example. Alternatively, the user inputs the entry qualification information to the KIOSK terminal. Then, the KIOSK terminal transmits the acquired entry qualification information and a face image obtained by imaging the user with the KIOSK terminal to the privilege information issuing apparatus 300. Note that in a case where a current location is used to issue the privilege information, the position information of the KIOSK terminal may be used. In addition, it is only necessary for the privilege information issuing apparatus 300 to notify the KIOSK terminal of the issued privilege information. At this time, the KIOSK terminal may display code information or the like of the privilege information such that the code information can be visually recognized by the user, and the user terminal may acquire the privilege information by scanning the code information displayed on the screen of the KIOSK terminal. Alternatively, the KIOSK terminal may print and output the code information or the like of the received privilege information. Alternatively, the privilege information issuing apparatus 300 may provide a notification of the privilege information issued with respect to the terminal information (user terminal) of the user specified by face authentication.

Note that the aforementioned issuing unit may select privilege information in accordance with attributes of the event, and issue and present the privilege information and notify the user of the privilege information. For example, in a case where the event is a sport game, a coupon that can be used at a support goods store may be issued to guide the user to the sales store. In addition, in a case where the event is a test, a coupon that can be used in a quiet cafe may be issued to guide the user to the cafe.

In the above-described example, the program includes a group of instructions (or software code) for causing a computer to perform one or more functions described in the example embodiments if the program is read by the computer. The program may be stored in a non-transitory computer-readable medium or a tangible storage medium. As an example and not by way of limitation, the computer-readable medium or the tangible storage medium includes a random-access memory (RAM), a read-only memory (ROM), a flash memory, a solid-state drive (SSD) or any other memory technology, a CD-ROM, a digital versatile disc (DVD), a Blu-ray (registered trademark) disc or any other optical disc storage, a magnetic cassette, a magnetic tape, and a magnetic disk storage or any other magnetic storage device. The program may be transmitted on a transitory computer-readable medium or a communication medium. By way of example, and not limitation, transitory computer-readable or communication media include electrical, optical, acoustic, or other forms of propagated signals.

Note that the present disclosure is not limited to the above example embodiments, and can be appropriately changed without departing from the gist. Furthermore, the present disclosure may be implemented by appropriately combining the respective example embodiments.

Some or all of the above example embodiments may be described as the following Supplementary Notes, but are not limited to the following.

### (Supplementary Note A1)

A privilege information issuing apparatus including:
a registration means for registering, in a storage means, entry qualification information with which a user is able to enter an event venue where an event is held through identity authentication and identity authentication information for registering the user who has purchased the entry qualification information in an associated manner;
an authentication control means for referring to the storage means and controlling the identity authentication using identity authentication information for authentication acquired from the user;
a specification means for specifying the entry qualification information associated with the identity authentication information with which the identity authentication has been successful;
an issuing means for issuing privilege information that is able to be used in one or more commercial facilities in a neighborhood of the event venue on the basis of the specified entry qualification information; and
a notification means for notifying the user of the issued privilege information.

### (Supplementary Note A2)

The privilege information issuing apparatus according to Supplementary Note A1, in which
the authentication control means controls the identity authentication at a time of payment by the user in the commercial facilities, and
the issuing means issues the privilege information that is able to be used in the commercial facilities at the time of the payment on the basis of the specified entry qualification information.

### (Supplementary Note A3)

The privilege information issuing apparatus according to Supplementary Note A2, in which the issuing means issues the privilege information including discount information that is able to be applied to a payment price at the time of the payment on the basis of the specified entry qualification information.

### (Supplementary Note A4)

The privilege information issuing apparatus according to any one of Supplementary Notes A1 to A3, in which
the specification means specifies seat information included in the specified entry qualification information, and
the issuing means issues the privilege information in accordance with the specified seat information.

### (Supplementary Note A5)

The privilege information issuing apparatus according to any one of Supplementary Notes A1 to A4, in which
a purchase history of the entry qualification information in past events is further registered in association with the identity authentication information in the storage means,
the specification means specifies the purchase history including the entry qualification information associated with the identity authentication information with which the identity authentication has been successful, and
the issuing means issues the privilege information in accordance with the specified purchase history.

### (Supplementary Note A6)

The privilege information issuing apparatus according to any one of Supplementary Notes A1 to A5, in which
the registration means further registers attribute information of the user in association with the identity authentication information in the storage means,
the specification means further specifies the attribute information associated with the identity authentication information with which the identity authentication has been successful, and
the issuing means issues the privilege information on the basis of the specified attribute information as well.

### (Supplementary Note A7)

The privilege information issuing apparatus according to Supplementary Note A6, in which
the event is a sport game,
the specification means further specifies a support target of the user on the basis of the specified attribute information, and
the issuing means issues the privilege information on the basis of the specified support target as well.

### (Supplementary Note A8)

The privilege information issuing apparatus according to Supplementary Note A7, in which the issuing means issues the privilege information in consideration of a relationship between the specified support target and a result of the sport game.

### (Supplementary Note A9)

The privilege information issuing apparatus according to Supplementary Note A7 or A8, in which
the attribute information includes seat information for watching the sport game, and
the specification means specifies the support target of the user from the seat information.

### (Supplementary Note A10)

The privilege information issuing apparatus according to Supplementary Note A7 or A8, in which
the attribute information includes a method of purchasing entry qualification information for the sport game, and
the specification means specifies the support target of the user from the method of purchasing.

### (Supplementary Note A11)

The privilege information issuing apparatus according to any one of Supplementary Notes A1 to A10, further including a providing means for providing information related to the user associated with the identity authentication information, with which the identity authentication has been successful, to the commercial facilities in a case where the user has made payment using the privilege information issued through the identity authentication in the commercial facility.

### (Supplementary Note A12)

The privilege information issuing apparatus according to any one of Supplementary Notes A1 to A11, in which
the identity authentication is biometric authentication, and
the identity authentication information is biometric information of the user.

### (Supplementary Note A13)

The privilege information issuing apparatus according to any one of Supplementary Notes A1 to A12, in which the commercial facilities are facilities in a cooperative relationship with the event venue.

### (Supplementary Note B1)

A privilege information issuing system including:
a storage apparatus; and
a privilege information issuing apparatus that is connected to the storage apparatus,
in which the privilege information issuing apparatus includes
a registration means for registering, in a storage means, entry qualification information with which a user is able to enter an event venue where an event is held through identity authentication and identity authentication information for registering the user who has purchased the entry qualification information in an associated manner,
an authentication control means for referring to the storage means and controlling the identity authentication using identity authentication information for authentication acquired from the user,
a specification means for specifying the entry qualification information associated with the identity authentication information with which the identity authentication has been successful,
an issuing means for issuing privilege information that is able to be used in one or more commercial facilities in a neighborhood of the event venue on the basis of the specified entry qualification information, and
a notification means for notifying the user of the issued privilege information.

### (Supplementary Note B2)

The privilege information issuing system according to Supplementary Note B1, in which
the authentication control means controls the identity authentication at a time of payment by the user in the commercial facilities, and
the issuing means issues the privilege information that is able to be used in the commercial facilities at the time of the payment on the basis of the specified entry qualification information.

### (Supplementary Note C1)

A privilege information issuing method including, by a computer:
registering, in a storage apparatus, entry qualification information with which a user is able to enter an event venue where an event is held through identity authentication and identity authentication information for registering the user who has purchased the entry qualification information in an associated manner;
referring to the storage apparatus and controlling the identity authentication using identity authentication information for authentication acquired from the user;
specifying the entry qualification information associated with the identity authentication information with which the identity authentication has been successful;
issuing privilege information that is able to be used in one or more commercial facilities in a neighborhood of the event venue on the basis of the specified entry qualification information; and
notifying the user of the issued privilege information.

### (Supplementary Note D1)

A non-transitory computer-readable medium that stores a privilege information issuing program that causes a computer to perform:
registration processing of registering, in a storage apparatus, entry qualification information with which a user is able to enter an event venue where an event is held through identity authentication and identity authentication information for registering the user who has purchased the entry qualification information in an associated manner;
authentication control processing of referring to the storage apparatus and controlling the identity authentication using identity authentication information for authentication acquired from the user;
specification processing of specifying the entry qualification information associated with the identity authentication information with which the identity authentication has been successful;
issuing processing of issuing privilege information that is able to be used in one or more commercial facilities in a neighborhood of the event venue on the basis of the specified entry qualification information; and notification processing of notifying the user of the issued privilege information.

Although the present invention has been described with reference to the example embodiments (and examples), the present invention is not limited to the above example embodiments (and examples). Various modified examples that can be understood by those skilled in the art can be made to the configuration and details of the present invention within the scope of the present invention.

Reference Signs List

| | |
|---|---|
| 1 | PRIVILEGE INFORMATION ISSUING APPARATUS |
| 11 | REGISTRATION UNIT |
| 12 | AUTHENTICATION CONTROL UNIT |
| 13 | SPECIFICATION UNIT |
| 14 | ISSUING UNIT |
| 15 | NOTIFICATION UNIT |
| 1000 | PRIVILEGE INFORMATION ISSUING SYSTEM |
| N | NETWORK |
| U1 | USER |
| U21 | FACILITY STAFF |
| U2n | FACILITY STAFF |
| U3 | AREA STAFF |
| 100 | USER TERMINAL |
| 110 | STORAGE UNIT |
| 111 | PROGRAM |
| 112 | TERMINAL INFORMATION |
| 120 | MEMORY |
| 130 | COMMUNICATION UNIT |
| 140 | CAMERA |
| 150 | TOUCH PANEL |
| 160 | CONTROL UNIT |
| 161 | REGISTRATION UNIT |
| 162 | PRIVILEGE PROCESSING UNIT |
| 200 | AUTHENTICATION APPARATUS |
| 210 | FACE INFORMATION DB |
| 211 | USER ID |
| 212 | FACE FEATURE INFORMATION |
| 220 | FACE DETECTION UNIT |
| 230 | FEATURE POINT EXTRACTION UNIT |
| 240 | REGISTRATION UNIT |
| 250 | AUTHENTICATION UNIT |
| 300 | PRIVILEGE INFORMATION ISSUING APPARATUS |
| 310 | STORAGE UNIT |
| 311 | PROGRAM |
| 312 | USER INFORMATION |
| 3121 | USER ID |
| 3122 | TERMINAL INFORMATION |
| 3123 | ATTRIBUTE INFORMATION |
| 3124 | PAYMENT INFORMATION |
| 3125 | ENTRY QUALIFICATION INFORMATION |
| 313 | PRIVILEGE INFORMATION MASTER |
| 3131 | PRIVILEGE ID |
| 3132 | TARGET FACILITY |
| 3133 | PRIVILEGE CONTENT |
| 3134 | ISSUING CONDITION |
| 314 | EVENT INFORMATION |
| 315 | PRIVILEGE MANAGEMENT INFORMATION |
| 3151 | ISSUED PRIVILEGE ID |
| 3152 | USER ID |
| 3153 | ISSUING DATE AND TIME |
| 3154 | VALIDITY PERIOD |
| 320 | MEMORY |
| 330 | COMMUNICATION UNIT |
| 340 | CONTROL UNIT |
| 341 | REGISTRATION UNIT |
| 342 | AUTHENTICATION CONTROL UNIT |
| 343 | SPECIFICATION UNIT |
| 344 | ISSUING UNIT |
| 345 | NOTIFICATION UNIT |
| 346 | ENTRY DETERMINATION UNIT |
| 347 | PAYMENT CONTROL UNIT |
| 348 | PROVIDING UNIT |
| 4 | AREA |
| 40 | EVENT VENUE |
| 401 | ENTRY CONTROL TERMINAL |
| 402 | EVENT HALL |
| 41 | COMMERCIAL FACILITY |
| 51 | PAYMENT TERMINAL |
| 61 | MANAGEMENT TERMINAL |
| 4n | COMMERCIAL FACILITY |
| 5n | PAYMENT TERMINAL |
| 6n | MANAGEMENT TERMINAL |
| 600 | MANAGEMENT TERMINAL |
| 410 | STORAGE UNIT |
| 411 | PROGRAM |
| 412 | TERMINAL INFORMATION |
| 420 | MEMORY |
| 430 | COMMUNICATION UNIT |
| 440 | CAMERA |
| 450 | TOUCH PANEL |
| 460 | CONTROL UNIT |
| 461 | RECEPTION UNIT |
| 462 | ENTRY CONTROL UNIT |
| 510 | STORAGE UNIT |
| 511 | PROGRAM |
| 512 | TERMINAL INFORMATION |
| 520 | MEMORY |
| 530 | COMMUNICATION UNIT |
| 540 | CAMERA |
| 550 | TOUCH PANEL |
| 560 | CONTROL UNIT |
| 561 | RECEPTION UNIT |
| 562 | PAYMENT CONTROL UNIT |
| 71 | COUPON |
| 711 | TARGET STORE |
| 712 | VALIDITY PERIOD |
| 713 | PRIVILEGE CONTENT |
| 714 | CODE INFORMATION |
| 715 | NOTIFICATION MESSAGE |
| 716 | REASON FOR ISSUANCE |
| 717 | PAYMENT PRICE INFORMATION BEFORE |
| | UTILIZATION OF COUPON |
| 718 | PAYMENT PRICE INFORMATION AFTER |
| | UTILIZATION OF COUPON |
| 71a | COUPON |
| 715a | NOTIFICATION MESSAGE |
| 72 | COUPON |
| 721 | TARGET STORE |
| 722 | VALIDITY PERIOD |
| 723 | PRIVILEGE CONTENT |
| 724 | CODE INFORMATION |
| 725 | NOTIFICATION MESSAGE |
| 726 | REASON FOR ISSUANCE |
| 727 | PAYMENT PRICE INFORMATION BEFORE |
| | UTILIZATION OF COUPON |
| 728 | PAYMENT PRICE INFORMATION AFTER |
| | UTILIZATION OF COUPON |
| 73 | COUPON |
| 731 | TARGET STORE |
| 732 | VALIDITY PERIOD |
| 733 | PRIVILEGE CONTENT |
| 734 | CODE INFORMATION |
| 735 | NOTIFICATION MESSAGE |
| 736 | REASON FOR ISSUANCE |
| 74 | COUPON |
| 741 | TARGET STORE |
| 742 | VALIDITY PERIOD |
| 743 | PRIVILEGE CONTENT |
| 744 | CODE INFORMATION |
| 745 | NOTIFICATION MESSAGE |
| 746 | REASON FOR ISSUANCE |
| 1000a | PRIVILEGE INFORMATION ISSUING SYSTEM |
| 300a | PRIVILEGE INFORMATION ISSUING APPARATUS |
| 620 | AREA MANAGEMENT SERVER |

What is claimed is:

1. A privilege information issuing apparatus comprising:
at least one storage device configured to store instructions; and
at least one processor configured to execute the instructions to:
register, in a storage apparatus, entry qualification information with which a user is able to enter an event venue where an event is held through identity authentication and identity authentication information for registering the user who has purchased the entry qualification information in an associated manner;
refer to the storage apparatus and control the identity authentication using identity authentication information for authentication acquired from the user;
specify the entry qualification information associated with the identity authentication information with which the identity authentication has been successful;
issue privilege information that is able to be used in one or more commercial facilities in a neighborhood of the event venue on the basis of the specified entry qualification information; and
notify the user of the issued privilege information.

2. The privilege information issuing apparatus according to claim 1, wherein the at least one processor is further configured to execute the instructions to:
control the identity authentication at a time of payment by the user in the commercial facilities, and
issue the privilege information that is able to be used in the commercial facilities at the time of the payment on the basis of the specified entry qualification information.

3. The privilege information issuing apparatus according to claim 2, wherein the at least one processor is further configured to execute the instructions to:
issue the privilege information including discount information that is able to be applied to a payment price at the time of the payment on the basis of the specified entry qualification information.

4. The privilege information issuing apparatus according to claim 1, wherein the at least one processor is further configured to execute the instructions to:
specify seat information included in the specified entry qualification information, and
issue the privilege information in accordance with the specified seat information.

5. The privilege information issuing apparatus according to claim 1, wherein
a purchase history of the entry qualification information in past events is further registered in association with the identity authentication information in the storage apparatus, and
wherein the at least one processor is further configured to execute the instructions to:
specify the purchase history including the entry qualification information associated with the identity authentication information with which the identity authentication has been successful, and
issue the privilege information in accordance with the specified purchase history.

6. The privilege information issuing apparatus according to claim 1, wherein the at least one processor is further configured to execute the instructions to:
register attribute information of the user in association with the identity authentication information in the storage apparatus,
specify the attribute information associated with the identity authentication information with which the identity authentication has been successful, and
issue the privilege information on the basis of the specified attribute information as well.

7. The privilege information issuing apparatus according to claim 6, wherein
the event is a sport game, and
wherein the at least one processor is further configured to execute the instructions to:
specify a support target of the user on the basis of the specified attribute information, and
issue the privilege information on the basis of the specified support target as well.

8. The privilege information issuing apparatus according to claim 7, wherein the at least one processor is further configured to execute the instructions to:
issue the privilege information in consideration of a relationship between the specified support target and a result of the sport game.

9. The privilege information issuing apparatus according to claim 7, wherein
the attribute information includes seat information for watching the sport game, and
wherein the at least one processor is further configured to execute the instructions to:
specify the support target of the user from the seat information.

10. The privilege information issuing apparatus according to claim 7, wherein
the attribute information includes a method of purchasing entry qualification information for the sport game, and
wherein the at least one processor is further configured to execute the instructions to:
specify the support target of the user from the method of purchasing.

11. The privilege information issuing apparatus according to claim 1, wherein the at least one processor is further configured to execute the instructions to:
provide information related to the user associated with the identity authentication information, with which the identity authentication has been successful, to the commercial facilities in a case where the user has made payment using the privilege information issued through the identity authentication in the commercial facility.

12. The privilege information issuing apparatus according to claim 1, wherein
the identity authentication is biometric authentication, and
the identity authentication information is biometric information of the user.

13. The privilege information issuing apparatus according to claim 1, wherein the commercial facilities are facilities in a cooperative relationship with the event venue.

14. A privilege information issuing system comprising:
a storage apparatus; and
a privilege information issuing apparatus that is connected to the storage apparatus, and including:
at least one storage device configured to store instructions; and
at least one processor configured to execute the instructions to:
register, in the storage apparatus, entry qualification information with which a user is able to enter an event venue where an event is held through identity authentication and identity authentication information for registering the user who has purchased the entry qualification information in an associated manner,
refer to the storage apparatus and control the identity authentication using identity authentication information for authentication acquired from the user,
specify the entry qualification information associated with the identity authentication information with which the identity authentication has been successful,
issue privilege information that is able to be used in one or more commercial facilities in a neighborhood of the event venue on the basis of the specified entry qualification information, and
notify the user of the issued privilege information.

15. The privilege information issuing system according to claim 14, wherein the at least one processor is further configured to execute the instructions to:
control the identity authentication at a time of payment by the user in the commercial facilities, and
issue the privilege information that is able to be used in the commercial facilities at the time of the payment on the basis of the specified entry qualification information.

16. A privilege information issuing method comprising, by a computer:
registering, in a storage apparatus, entry qualification information with which a user is able to enter an event venue where an event is held through identity authentication and identity authentication information for registering the user who has purchased the entry qualification information in an associated manner;
referring to the storage apparatus and controlling the identity authentication using identity authentication information for authentication acquired from the user;
specifying the entry qualification information associated with the identity authentication information with which the identity authentication has been successful;
issuing privilege information that is able to be used in one or more commercial facilities in a neighborhood of the event venue on the basis of the specified entry qualification information; and
notifying the user of the issued privilege information.

17. A non-transitory computer-readable medium that stores a privilege information issuing program that causes a computer to perform:
registration processing of registering, in a storage apparatus, entry qualification information with which a user is able to enter an event venue where an event is held through identity authentication and identity authentication information for registering the user who has purchased the entry qualification information in an associated manner;
authentication control processing of referring to the storage apparatus and controlling the identity authentication using identity authentication information for authentication acquired from the user;
specification processing of specifying the entry qualification information associated with the identity authentication information with which the identity authentication has been successful;
issuing processing of issuing privilege information that is able to be used in one or more commercial facilities in a neighborhood of the event venue on the basis of the specified entry qualification information; and
notification processing of notifying the user of the issued privilege information.
